(19) United States
(12) Patent Application Publication
(10) Pub. No.: US 2021/0208387 A1
(43) Pub. Date: Jul. 8, 2021

(54) ELECTROWETTING DEVICES

(71) Applicant: CORNING INCORPORATED, CORNING, NY (US)

(72) Inventor: Raymond Miller Karam, Santa Barbara, CA (US)

(21) Appl. No.: 17/056,851

(22) PCT Filed: May 21, 2019
(86) PCT No.: PCT/US2019/033270

§ 371 Date: Nov. 19, 2020

Related U.S. Application Data
(60) Provisional application No. 62/675,061, filed on May 22, 2018.
(60) Provisional application No. 62/674,957, filed on May 22, 2018.

(51) Int. Cl. G02B 26/00; G03B 13/36; G03B 5/00

(52) U.S. Cl. CPC G02B 26/005; G03B 2205/0046; G03B 5/00; G03B 13/36

(57) ABSTRACT

An optical device can include an optical member, positioned at an interface between a first liquid and a second liquid. The optical member can be positionally actuated using the first and second liquid. The optical member may include a plastic lens, a ball lens, a ball lens array, an actuated liquid lens, a biconcave lens, a biconvex lens, a plano-convex, a plano-concave, a negative meniscus lens, a positive meniscus lens, a convex-concave lens, or a concave-convex lens, or any other suitable lens type. The optical member can be actuated in an optical tilt direction, in a left-right horizontal direction, in an up-down vertical direction, in a yaw rotational direction, in an axial direction, or a combination thereof. The optical member can be actuated using electrowetting, using magneto rheological fluids, using static electrofields, using electrical actuation, or using mechanical actuation, for example.

### CROSS-REFERENCE TO RELATED APPLICATIONS

This application claims the benefit of U.S. Provisional Patent Application No. 62/675,061, filed May 22, 2018, and titled ELECTROWETTING DEVICES, and U.S. Provisional Patent Application No. 62/674,957, filed May 22, 2018, and titled MENISCUS-PINNED ELECTROWETTING OPTICAL DEVICES. The entirety contents of each of the above-identified applications are hereby incorporated by reference herein and made part of this specification for all that they disclose.

### BACKGROUND

### Field of the Disclosure

Some embodiments of this disclosure relate to electrowetting devices, such as liquid lenses, and electrowetting actuators, which in some cases can be used to implement a zoom lens, a variable focus lens, and/or an optical image stabilization system for a camera system. Some embodiments can relate to meniscus-pinned optical devices, such as for use in a liquid lens and, in some cases, to a meniscus-pinned lens that can be actuated in an electrowetting optical device using two or more liquids.

### Description of the Related Art

Although some electrowetting devices are known, there remains a need for improved electrowetting devices, such as for use in camera systems and/or active lenses.

### SUMMARY

Some embodiments disclosed herein can relate to a camera system, which can include an imaging sensor and a movable lens device, which can have a housing, a microlens array (or other lens type or other optical element) disposed inside the housing. Microlens elements of the microlens array can be configured to at least contribute to focusing of light onto the image sensor. Other optical elements can perform other operations on the light. One or more fluid bodies can be made of a first fluid and can be coupled to the microlens array and to the housing, such as to suspend the microlens array inside the housing. The device can include a plurality of electrodes and a controller configured to deliver signals to the electrodes, such as to move the microlens array to implement one or more of optical image stabilization, optical zoom, and autofocus.

The controller can be configured to deliver signals to the electrodes to move the microlens array to implement each of optical image stabilization, optical zoom, and autofocus, or any combination thereof. The camera system can include an optical zoom system. The controller can be configured to receive target zoom information and determine the signals to deliver to the electrodes to move the microlens array to change magnification of an image provided to the imaging sensor. The camera system of claim 1, comprising an optical image stabilization system that includes a sensor that provides information indicative of camera motion, wherein the controller is configured to receive the information indicative of camera motion, and determine the signals to deliver to the electrodes to move the microlens array to at least partially compensate for the camera motion. The camera can have an autofocus system. The controller can be configured to receive target focal information, and determine the signals to deliver to the electrodes to move the microlens array to change a focal length. The camera system can be configured such that the signals to the electrodes change the area of contact between the fluid bodies and the housing. Increasing the area of contact can pull the microlens array closer to the corresponding electrode. Decreasing the area of contact can push the microlens array away from the corresponding electrode. The camera system can be configured such that the signals to the electrodes cause the fluid bodies to move from a first area over a first electrode to a second area over a second electrode adjacent to the first electrode.

Some embodiments disclosed herein can relate to an electrowetting device, which can include a housing that contains a cavity, a first window, and a second window. An axis can extend from the first window to the second window. An optical element can be disposed inside the cavity. The device can have one or more fluid bodies of a first fluid. The fluid bodies can be coupled to the optical element (e.g., directly or indirectly). The fluid bodies can be coupled to the housing (e.g., directly or indirectly). The fluid bodies can suspend the optical element in the cavity. A second fluid can at least partially surround the one or more fluid bodies. One or more electrodes can be electrically insulated from the first fluid and the second fluid. The electrodes can be positioned so that signals applied to the one or more electrodes cause the one or more fluid bodies to move the optical element.

The electrowetting device can include one or more additional electrodes that can be in electrical communication with the first fluid of the one or more fluid bodies. The first fluid can be electrically conductive, and the second fluid can be electrically insulating. In some embodiments, the electrowetting device can include a common electrode that is in electrical communication with the second fluid. The first fluid can be electrically insulating, and the second fluid can be electrically conductive. The electrowetting device can be configured to move the optical element axially. The electrowetting device can be configured to move the optical element laterally. The electrowetting device can be configured to tilt the optical element relative to the axis. The electrowetting device can be configured to move the optical element with at least 5 degrees of freedom. The electrowetting device can include an inner housing that holds the optical element. The fluid bodies can be coupled to the inner housing. The inner housing can hold an additional optical element. The optical element can include a microlens array. The optical element can include a liquid lens. The electrowetting device can be configured to deliver signals to the liquid lens by induction. The electrowetting device can be configured to deform shapes of the one or more fluid bodies to move the optical element. The electrowetting device can be configured to move the one or more fluid bodies from one or more first electrodes to one or more second electrodes to move the optical element.

Some embodiments disclosed herein can relate to an electrowetting device, which can include a first fluid disposed within a cavity and a second fluid disposed within the cavity. At least one interface can be between the first fluid and the second fluid. In some embodiments, the first and second fluids can be substantially immiscible with each other to form the interface. An optical element (e.g., a lens element) can be disposed within the cavity, and can be suspended by one or both of the first fluid or the second fluid. A first electrode can be insulated from the first and second fluids. A second electrode can be electrical communication with the first fluid, in some embodiments. Adjusting a voltage differential between the first electrode and the second electrode can cause movement of the optical element relative to the cavity.

The optical element can include a microlens array. The optical element can include a ball lens array. The optical element can include a biconvex lens, a plano-convex lens, a meniscus lens, a plano-concave lens, a biconcave lens, a Fresnel lens, a diffraction grating, or a combination thereof. The movement of the optical element can be caused at least in part by a change in wettability of a portion of an inside wall of the cavity relative to the first fluid or the second fluid resulting at least in part from adjusting the voltage differential. The electrowetting device can include one or more fluid bodies made of the first fluid or the second fluid. A first portion of the one or more fluid bodies can be coupled to an inside wall of the cavity. A second portion of the one or more fluid bodies can be coupled to the optical element or an internal housing that supports the optical element. Adjusting the voltage differential can change the size of the first portion of one of the fluid bodies to move the optical element. Adjusting the voltage differential can move one of the fluid bodies from an area over an initial electrode to an area over an adjacent electrode to move the optical element. The optical element can be movable with at least 5 degrees of freedom.

According to some embodiments of the present disclosure, an optical device is provided. The optical device can include an optical member positioned at an interface between a first liquid and a second liquid. The optical member can be positionally actuated using the first and second liquid.

The optical member can include a plastic lens, a ball lens, a ball lens array, an actuated liquid lens, a biconcave lens, a biconvex lens, a plano-convex lens, a plano-concave lens, a negative meniscus lens, a positive meniscus lens, a convex-concave lens, or a concave-convex lens, a diffraction grating, or a combination thereof. The optical member can be positionally actuated in a tilted direction using the first and second liquid. The optical member can be positionally actuated in a lateral (e.g., left-right horizontal) direction using the first and second liquid. The optical member can be positionally actuated in an axial (e.g., an up-down vertical) direction using the first and second liquid. The optical member can be positionally actuated in a yaw rotational direction using the first and second liquid. The optical member can be positionally actuated using electrowetting. The optical member can be positionally actuated using magneto rheological fluids. The optical member, the first liquid, and the second liquid can be electrically charged to positionally actuate the optical member. The optical device can include an electrowetting optical device that has a first window, a second window, and a cavity disposed between the first window and the second window. A non-conductive liquid and a polar liquid can be disposed within the cavity. The nonconductive liquid and the polar liquid can be substantially immiscible with each other. The nonconductive liquid and the polar liquid can have different refractive indices such that an interface between the non-conductive liquid and the polar liquid defines a variable lens. A common electrode can be electrical connection with the first liquid. A driving electrode can be disposed on a sidewall of the cavity and insulated from the non-conductive liquid and the polar liquid, such as by an insulating polymer dielectric layer. The electrowetting optical device can be coupled in optical communication with the optical device.

According to some embodiments of the present disclosure, an optical device can include: a first window, a second window, and a cavity disposed between the first window and the second window. A first liquid and a second liquid can be disposed within the cavity. The first liquid and the second liquid can be substantially immiscible with each other, in some embodiments, forming an interface. An optical member can be positioned at the interface between the first liquid and the second liquid. The optical member can be actuated using the first and second liquid.

The optical device can include an electrode, which can be disposed on a sidewall of the cavity. The optical member can include a plastic lens, a ball lens, a ball lens array, an actuated liquid lens, a biconcave lens, a biconvex lens, a plano-convex lens, a plano-concave lens, a negative meniscus lens, a positive meniscus lens, a convex-concave lens, or a concave-convex lens, a diffraction grating, or a combination thereof. The optical member can be positionally actuated in an optical tilt direction, in a lateral direction (e.g., left-right horizontal direction), or in an axial (e.g., up-down vertical) direction, or combinations thereof), in a yaw rotational direction, or a combination thereof. The optical member can be positionally actuated using electrowetting, using magneto rheological fluids, using static electrofields, using electrical actuation, or using mechanical actuation, or any combination thereof.

According to some embodiments of the present disclosure, a method for actuating an optical member in an optical device is provided. The method can include positioning the optical member at an interface between a first liquid and a second liquid and actuating the optical member in an optical tilt direction, in a left-right horizontal direction, in an up-down vertical direction, in a yaw rotational direction, or a combination thereof. The actuation can be performed using the first liquid and the second liquid, for example.

The optical member can include a plastic lens, a ball lens, a ball lens array, an actuated liquid lens, a biconcave lens, a biconvex lens, a plano-convex, a plano-concave, a negative meniscus lens, a positive meniscus lens, a convex-concave lens, a concave-convex lens, or a diffraction grating, or any other suitable optical element. The actuation can use electrowetting. The actuation can use magneto rheological fluids. The actuation can use static electrofields.

Certain example embodiments are summarized above for illustrative purposes. The embodiments are not limited to the specific implementations recited herein. Embodiments may include several novel features, no single one of which is solely responsible for its desirable attributes or which is essential to the embodiments. Additional features and advantages will be set forth in the detailed description which follows, and will be readily apparent to those skilled in the art from that description or recognized by practicing the embodiments as described herein, including the detailed description which follows, the claims, as well as the appended drawings. It is to be understood that both the foregoing general description and the following detailed description are merely exemplary, and are intended to provide an overview or framework to understanding the nature and character of the disclosure and the appended claims. The accompanying drawings are included to provide a further understanding of principles of the disclosure, and are incorporated in, and constitute a part of, this specification. The drawings illustrate one or more embodiment(s) and, together with the description, serve to explain, by way of example, principles and operation of the disclosure. It is to be understood that various features of the disclosure disclosed in this specification and in the drawings can be used in any and all combinations. By way of non-limiting examples, the various features of the disclosure may be combined with one another according to the following embodiments.

### BRIEF DESCRIPTION OF THE DRAWINGS

Certain embodiments will be discussed in detail with reference to the following figures, wherein like reference numerals refer to similar features throughout. These figures are provided for illustrative purposes and the embodiments are not limited to the specific implementations illustrated in the figures. The following is a description of the figures in the accompanying drawings. The figures are not necessarily to scale, and certain features and certain views of the figures may be shown exaggerated in scale or in schematic in the interest of clarity and conciseness.

FIG. 1 is a cross-sectional view of an example embodiment of a liquid lens.

FIG. 2 is a cross-sectional view of an example embodiment of a liquid lens in a driven state with an applied voltage differential.

FIG. 3 is a plan view of an example embodiment of a liquid lens with four insulated electrodes.

FIG. 4 is a cross-sectional view of an example embodiment of a liquid lens with a tilted fluid interface.

FIG. 5 is a block diagram of an example embodiment of a camera system, which can include a liquid lens.

FIG. 6 is a cross-sectional view of an example embodiment of a movable lens system.

FIG. 7 is cross-sectional view of the movable lens system taken orthogonal to FIG. 6.

FIG. 8 is cross-sectional view of the movable lens system with the lens element moved laterally.

FIG. 9 shows another example embodiment of a movable lens system.

FIG. 10 shows another example embodiment of a movable lens system in an undriven state.

FIG. 11 shows the example embodiment of a movable lens system of FIG. 10 in an example driven state.

FIG. 11A shows another example of a movable lens system.

FIG. 11B shows another example of a movable lens system.

FIG. 12 is a cross-sectional view of another example embodiment of a movable lens system.

FIG. 13 shows the movable lens system of FIG. 12, driven to move the lens element axially.

FIG. 14 shows the movable lens system of FIG. 12, driven to tilt the lens element.

FIG. 15 is a cross-sectional view of another example embodiment of a movable lens system.

FIG. 16 is a cross-sectional view of another example embodiment of a movable lens system shown in an undriven state.

FIG. 17 is a cross-sectional view of the movable lens system of claim 16 shown in a driven state.

FIG. 18 is a cross-sectional view of another example of a movable lens system, with a movable lens element at a first position.

FIG. 19 is a cross-sectional view of the movable lens system of FIG. 18, with the movable lens element at a second position.

FIG. 20 is a cross-sectional view of another example of a movable lens system.

FIG. 21 shows an example embodiment of interdigitated electrodes.

FIG. 22 shows another example embodiment of interdigitated electrodes.

FIGS. 23 to 28 show example embodiments of an inner housing with various combinations of one or more optical elements.

FIG. 29 shows a system for transfer of control and/or power signals by induction.

FIGS. 30 to 33 shows examples of fluid bodies advancing across various positions relative to a series of electrodes.

FIG. 34 shows an example set of drive signals for electrodes in a movable lens system.

FIG. 35 shows an example embodiment of a movable lens system, which can use magnetism to move a lens element, which can be suspended using one or more fluids.

FIG. 36 shows the example embodiment of FIG. 35 in driven state.

FIGS. 37A-37C are a group of schematic cross-sectional views of an optical device positionally actuating an optical member in an up-down vertical direction (e.g., axially) according to some embodiments of the present disclosure.

FIGS. 38A-38C are a group of schematic cross-sectional views of an optical device positionally actuating an optical member in a left-right horizontal direction (e.g., laterally) according to some embodiments of the present disclosure.

FIG. 39 is a schematic cross-sectional view of an optical device able to positionally actuate an optical member laterally (e.g., in a left-right horizontal direction) and axially (e.g., in an up-down vertical direction) according to some embodiments of the present disclosure.

FIG. 40 is a schematic cross-sectional view of an optical device able to positionally actuate an optical member in a left-right horizontal direction (e.g., laterally) and an up-down vertical direction (e.g., axially) according to some embodiments of the present disclosure.

FIG. 41 is a schematic cross-sectional view of an optical device coupled in optical communication with an electrowetting optical device according to some embodiments of the present disclosure.

### DETAILED DESCRIPTION OF CERTAIN EMBODIMENTS

Additional features and advantages will be set forth in the detailed description which follows and will be apparent to those skilled in the art from the description, or recognized by practicing the embodiments as described in the following description, together with the claims and appended drawings.

Liquid Lens System

In some cases, electrowetting based liquid lenses can be based on two immiscible liquids disposed within a chamber, namely an oil and a conductive phase, the latter being water based. The two liquid phases can form a triple interface on an isolating substrate comprising a dielectric material. Varying an electric field applied to the liquids can vary the wettability of one of the liquids relative to walls of the chamber, which can have the effect of varying the shape of a meniscus formed between the two liquids. Further, in various applications, changes to the shape of the meniscus can result in changes to the focal length and/or focal direction of the lens.

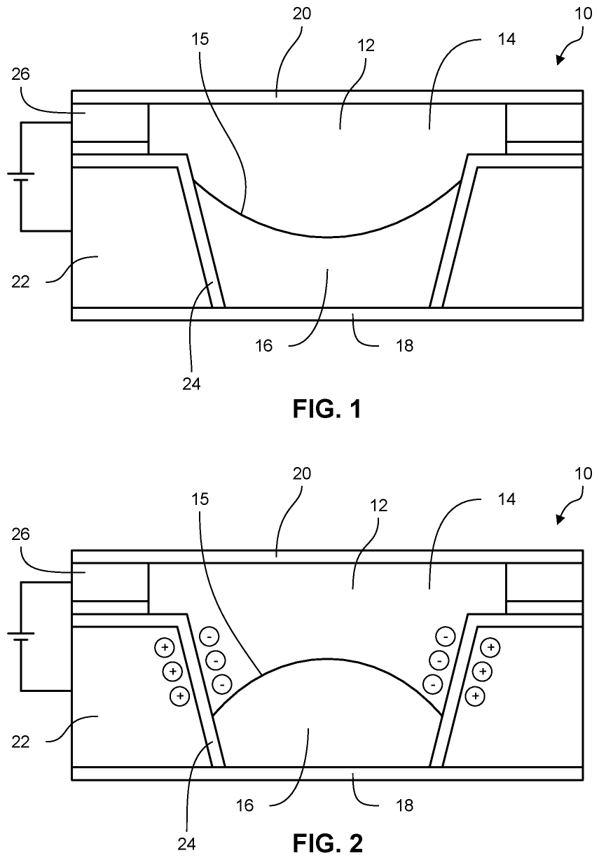

FIG. 1 is a cross-sectional view of an example embodiment of a liquid lens 10. The liquid lens 10 can have a cavity 12 that contains at least two fluids (e.g., liquids), such as first fluid 14 and a second fluid 16. The two fluids can be substantially immiscible so that a fluid interface 15 is formed between the first fluid 14 and the second fluid 16. Although some embodiments disclosed herein show a fluid interface between two fluids that directly contact each other, the interface can be formed by a membrane or other intermediate structure or material between two fluids. For example, embodiments disclosed herein can be modified to use various different fluids, such as those that could mix if in direct contact. In some embodiments the two fluids 14 and 16 can be sufficiently immiscible such as to form the fluid interface 15. The interface 15, when curved for example, can refract light with optical power as a lens. The first fluid 14 can be electrically conductive, and the second fluid 16 can be electrically insulating. The first fluid 14 can be a polar fluid, such as an aqueous solution, in some embodiments. The second fluid 16 can be an oil, in some embodiments. The first fluid 14 can have a higher dielectric constant than the second fluid 16. The first fluid 14 and the second fluid 16 can have different indices of refraction, for example so that light can be refracted at it passes through the fluid interface 15. The first fluid 14 and the second fluid 16 can have substantially similar densities, which can impede either of the fluids 14 and 16 from floating relative to the other.

The cavity 12 can include a portion having a shape of a frustum or truncated cone. The cavity 12 can have angled side walls. The cavity 12 can have a narrow portion where the side walls are closer together and a wide portion where the side walls are further apart. The narrow portion can be at the bottom end of the cavity 12 and the wide portion can be at the top end of the cavity 12 in the orientation shown, although the liquid lenses 10 disclosed herein can be positioned at various other orientations. The edge of the fluid interface 15 can contact the angled side walls of the cavity 12. The edge of the fluid interface 15 can contact the portion of the cavity 12 having the frustum or truncated cone shape. Various other cavity shapes can be used. For example, the cavity can have curved side walls (e.g., curved in the cross-sectional view of FIGS. 1-2). The side walls can conform to the shape of a portion of a sphere, toroid, or other geometric shape. In some embodiments, the cavity 12 can have a cylindrical shape. In some embodiments, the cavity can have a flat surface and the fluid interface can contact the flat surface (e.g., as a drop of the second fluid 16 sitting on the base of the cavity 12).

A lower window 18, which can include a transparent plate, can be below the cavity 12. An upper window 20, which can include a transparent plate, can be above the cavity 12. The lower window 18 can be located at or near the narrow portion of the cavity 12, and/or the upper window 20 can be located at or near the wide portion of the cavity 12. The lower window 18 and/or the upper window 20 can be configured to transmit light therethrough. The lower window 18 and/or the upper window 20 can transmit sufficient light to form an image, such as on an imaging sensor of a camera. In some cases, the lower window 18 and/or the upper window 20 can absorb and/or reflect a portion of the light that impinges thereon.

A first one or more electrodes 22 (e.g., insulated electrodes) can be insulated from the fluids 14 and 16 in the cavity 12, such as by an insulation material 24. A second one or more electrodes 26 can be in electrical communication with the first fluid 14. The second one or more electrodes 26 can be in contact with the first fluid 14. In some embodiments, the second one or more electrodes 26 can be capacitively coupled to the first fluid 14. Voltages can be applied between the electrodes 22 and 26 to control the shape of the fluid interface 15 between the fluids 14 and 16, such as to vary the focal length of the liquid lens 10. Direct current (DC) voltage signals can be provided to one or both of the electrodes 22 and 26. Alternating current (AC) voltage signals can be provided to one or both of the electrodes 22 and 26. The liquid lens 10 can respond to the root mean square (RMS) voltage signal resulting from the AC voltage(s) applied. In some embodiments, AC voltage signals can impede charge from building up in the liquid lens 10, which can occur in some instances with DC voltages. In some embodiments, the first fluid 14 and/or the second one or more electrodes 26 can be grounded. In some embodiments, the first one or more electrodes 22 can be grounded. In some embodiments, voltage can be applied to either the first electrode(s) 22 or the second electrode(s) 26, but not both, to produce voltage differentials. In some embodiments, voltage signals can be applied to both the first electrode(s) 22 and the second electrode(s) 26 to produce voltage differentials.

FIG. 1 shows the liquid lens 10 in a first state where no voltage is applied between the electrodes 22 and 26, and FIG. 2 shows the liquid lens 10 in a second state where a voltage is applied between the electrodes 22 and 26. The chamber 12 can have one or more side walls made of a hydrophobic material. For example the insulating material 24 can be parylene, which can be insulating and hydrophobic, although various other suitable materials can be used. When no voltage is applied, the hydrophobic material on the side walls can repel the first fluid 14 (e.g., an aqueous solution) so that the second fluid 16 (e.g., an oil) can cover a relatively large area of the side walls to produce the fluid interface 15 shape shown in FIG. 1. When a voltage is applied between the first electrode 22 and the first fluid 14 (e.g., via the second electrode 26), the first fluid 14 can be attracted to the first electrode 22, which can drive the location of the fluid interface 15 down the side wall so that more of the side walls are is in contact with the first fluid 14. Changing the applied voltage differential can change the contact angle between the edge of the fluid interface 15 and the surface of the cavity 12 (e.g., the angled side wall of the truncated cone portion of the cavity 12) based on the principle of electrowetting. The fluid interface 15 can be driven to various different positions by applying different amounts of voltage between the electrodes 22 and 26, which can produce different focal lengths or different amounts of optical power for the liquid lens 10.

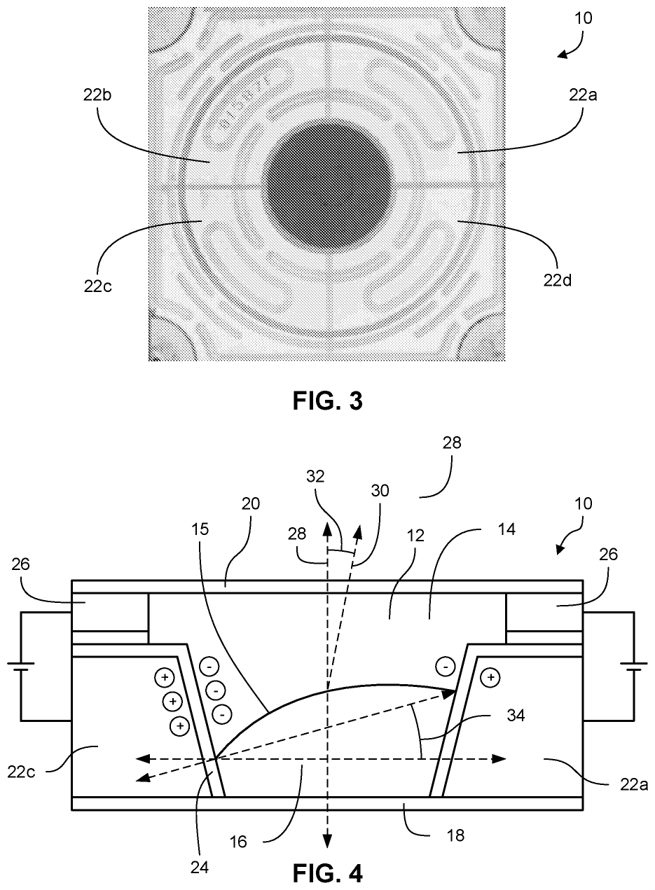

FIG. 3 shows a plan view of an example embodiment of a liquid lens 10. In some embodiments, the first one or more electrodes 22 (e.g., insulated electrodes) can include multiple electrodes 22 positioned at multiple locations on the liquid lens 10. The liquid lens 10 can have four electrodes 22a, 22b, 22c, and 22d, which can be positioned in four quadrants of the liquid lens 10. In other embodiments, the first one or more electrodes 22 can include various numbers of electrodes (e.g., 1 electrode, 2 electrodes, 4 electrodes, 6 electrodes, 8 electrodes, 12 electrodes, 16 electrodes, 32 electrodes, or more, or any values therebetween). Although various examples are provided herein with even numbers of insulated electrodes 22, odd numbers of insulated electrodes 22 can also be used. The electrodes 22a-d can be driven independently (e.g., having the same or different voltages applied thereto), which can be used to position the fluid interface 15 at different locations on the different portions (e.g., quadrants) of the liquid lens 10. FIG. 4 shows a cross-sectional view taken through opposing electrodes 22a and 22c. If more voltage is applied to the electrode 22c than to the electrode 22a, as shown in FIG. 4, the fluid interface 15 can be pulled further down the sidewall at the quadrant of the electrode 22c than at the quadrant of the electrode 22a.

The tilted fluid interface 15 can turn light that is transmitted through the liquid lens 10. The liquid lens 10 can have an axis 28. The axis 28 can be an axis of symmetry for at least a portion of the liquid lens 10. For example, the cavity 12 can be substantially rotationally symmetrical about the axis 28. The truncated cone portion of the cavity 12 can be substantially rotationally symmetrical about the axis 28. The axis 28 can be an optical axis of the liquid lens 10. For example, the curved and untilted fluid interface 15 can converge light towards, or diverge light away from, the axis 28. The axis 28 can be a longitudinal axis of the liquid lens 10, in some embodiments. Tilting the fluid interface 15 can turn the light 30 passing through the tilted fluid interface relative to the axis 28 by an optical tilt angle 32. The light 30 that passed through the tilted fluid interface 15 can converge towards, or diverge away from, a direction that is angled by the optical tilt angle 32 relative to the direction along which the light entered the liquid lens 10. The fluid interface 15 can be tilted by physical tilt angle 34 that produces the optical tilt angle 32. The relationship between the optical tilt angle 32 and the physical tilt angle 34 depends at least in part on the indices of refraction of the fluids 14 and 16.

The optical tilt angle 32 produced by tilting the fluid interface 15 can be used by a camera system to provide optical image stabilization, off-axis focusing, etc. In some cases different voltages can be applied to the electrodes 22a-d to compensate for forces applied to the liquid lens 10 so that the liquid lens 10 maintains on-axis focusing. Voltages can be applied to control the curvature of the fluid interface 15, to produce a desired optical power or focal length, and the tilt of the fluid interface 15, to produce a desired optical tilt (e.g., an optical tilt direction and an amount of optical tilt). Accordingly, the liquid lens 10 can be used in a camera system to produce a variable focal length while simultaneously producing optical image stabilization.

Camera System

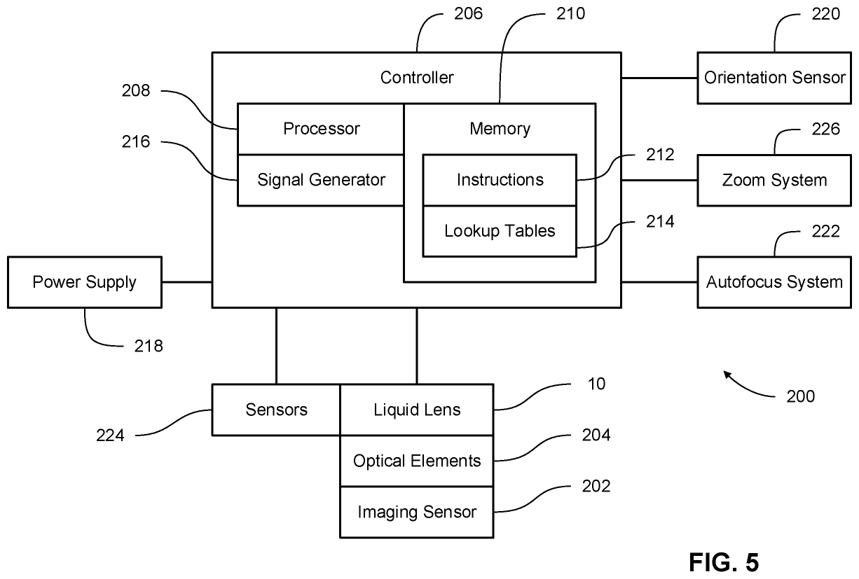

FIG. 5 is a block diagram of an example embodiment of a camera system 200, which can include a liquid lens 10, which can include features of any of the liquid lens embodiments disclosed herein. The camera system 200 can include an imaging sensor 202, which can be used to produce an image from light that impinges on the imaging sensor 202. The imaging sensor 202 can be a charge-coupled device (CCD) sensor, a complementary metal-oxide semiconductor (CMOS) sensor, or any other suitable electronic imaging sensor. In some embodiments, photographic film can be used to produce an image, or any other suitable type of imaging sensor. The liquid lens 10 can direct light toward the imaging sensor 202. In some embodiments, the camera system 200 can include one or more additional optical elements 204 that operate on the light propagating toward the imaging sensor 202. The optical elements 204 can include one or more fixed lenses (e.g., a fixed lens stack), one or more movable lenses, one or more optical filters, or any other suitable optical elements for producing desired optical effects. The liquid lens 10 can operate on the light propagating towards the imaging sensor 202 before the one or more optical elements 204, after the one or more optical elements 204, or the liquid lens 10 can be positioned optically between optical elements 204. When light is described herein as propagating towards a component (e.g., towards the imaging sensor 202), the light can be propagating along a path that directly or indirectly leads to the component. For example, light can pass through the liquid lens 10 in a first direction while propagating along an optical path towards the imaging sensor 202, and the light can be redirected (e.g., reflected by a mirror and/or turned by refraction) to continue in a second direction (which can be different than, and even opposite to, the first direction) along the optical path towards the imaging sensor 202.

The camera system 200 can include a controller 206 for operating the liquid lens 10, the other optical elements 204, and/or other components of the system 200, for example to implement the liquid lens features and/or other functionality disclosed herein. The controller 206 can operate various aspects of the camera system 200. For example, a single controller 206 can operate the liquid lens 10, can operate the imaging sensor 202, can store images produced by the imaging sensor 202, can operate other components of the camera, such as a display, a shutter, a user interface, etc. In some embodiments, any suitable number of controllers can be used to operate the various aspects of the camera system 200. The controller 206 can output voltage signals to the liquid lens 10. For example, the controller 206 can output voltage signals to the insulated electrode(s) 22 and/or the electrode(s) in electrical communication with the conductive fluid 14, and the voltage signals can control the curvature of the fluid interface 15 (e.g., to produce a desired optical power) and/or to control the tilt of the fluid interface 15 (e.g., to produce a desired optical tilt). The controller 206 can output DC voltage signals, AC voltage signals, pulsed DC voltage signals, or any other suitable signals for driving the liquid lens 10.

The controller 206 can include at least one processor 208. The processor 208 can be a hardware processor. The processor 208 can be a computer processor. The processor 208 can be in communication with a computer-readable memory 210. The memory 210 can be non-transitory computer-readable memory. The memory 210 can include one or more memory elements, which can be of the same or different types. The memory 210 can include a hard disk, flash memory, RAM memory, ROM memory, or any other suitable type of computer-readable memory. The processor 206 can execute computer-readable instructions 212 stored in the memory 210 to implement the functionality disclosed herein. In some embodiments, the processor 208 can be a general purpose processor. In some embodiments, the processor 208 can be a specialized processor that is specially configured to implement the functionality disclosed herein. The processor 208 can be an application specific integrated circuit (ASIC) and/or can include other circuitry configured to perform the functionality disclosed herein, such as to operate the liquid lens 10 as discussed herein.

The memory 210 can include one or more lookup tables 214, which can be used in determining the voltage signals to be applied to the liquid lens 10. The processor 208 can be configured to implement, and/or the computer-readable instructions 212 can include, one or more algorithms, equations, or formulas to be used in determining the voltage signals to be applied to the liquid lens 10. The processor 208 can determine the voltages to be applied to the liquid lens 10 (e.g., using one or more lookup tables 214 and/or one or more algorithms, equations, or formulas). Other information can be stored in the memory 210, such as images produced by the camera system 200, instructions for operating other components of the camera system 200, etc.

The controller 206 can include a signal generator 216, which can generate the voltage signals to be provided to the liquid lens 10. The signal generator 216 can generate the voltage signals in response to the voltage values determined by the processor 208. The signal generator 216 can include one or more amplifiers, switches, H-bridges, half-bridges, rectifiers, and/or any other suitable circuitry for producing the voltage signals. A power supply 218 can be used to produce the voltage signals to be provided to the liquid lens 10. The power supply 218 can be a battery, a DC power source, an AC power source, or any suitable source of electrical power. The signal generator 216 can receive power from the power supply 218 and can modulate or otherwise modify the electrical signals (e.g., based on determinations made by the processor 208) to provide driving signals to the liquid lens 10. In some embodiments, the processor 208 and the signal generator 216 can be implemented together is a single integrated circuit (IC) or in combined circuitry.

In some embodiments, the controller 206 can receive input from an orientation sensor 220, such as a gyroscope, accelerometer, and/or other suitable sensor for providing information regarding the orientation of the camera system 200 and/or the liquid lens 10. In some embodiments, the orientation sensor 220 can be a MEMS (micro-electro-mechanical system) device. The orientation sensor 220 can provide a measurement of angular velocity, acceleration, or any suitable measurement that can be used to determine a desired optical tilt for the liquid lens 10. In some cases, when the camera system 200 shakes (e.g., in response to being held by a human, or vibrations from a driving car, etc.) the orientation sensor 220 (e.g., gyroscope) can provide input to the controller 206 regarding the shaking, and the liquid lens 10 can be driven to at least partially counter the shaking of the camera system 200 by controlling the tilt of the fluid interface 15 (e.g., tilt direction and amount of tilt).

The controller 206 (e.g., using the processor 208) can determine an optical tilt amount (e.g., angle 32) and/or an optical tilt direction (e.g., an angle) based at least in part on the input received from the orientation sensor 220, although in some embodiments these parameters can be received by the liquid lens controller 206 (e.g., determined by the orientation sensor 220 or some other component of the camera system 200). The signals for driving the liquid lens 10 (e.g., voltage signals) can be determined at least in part based on the optical tilt amount and/or optical tilt direction. In some cases, the controller 206 (e.g., using the processor 208) can determine a physical tilt amount (e.g., angle 34) and/or a physical tilt direction (e.g., an azimuthal angle) for the fluid interface 15. These can be determined from the optical tilt amount and/or optical tilt direction, or can be determined directly from the input received from the orientation sensor 220. The controller 206 (e.g., using the processor 208) can determine driver signals (e.g., voltages) for the electrodes (e.g., the insulated electrodes 22a-d in the embodiment of FIG. 3) to implement the physical tilt of the fluid interface 15. In some embodiments, the driver signals can be determined from the input received from the orientation sensor 220 directly, such as without determining the desired optical tilt, without determining the desired physical tilt of the fluid interface 15, and/or without determining any other intermediate values or parameters.

Many variations are possible. In some embodiments, the orientation sensor 220 can be omitted. For example, the camera system 200 can perform optical image stabilization (OIS) in response to image analysis or any other suitable approach. The controller 206 can receive OIS input information (e.g., derived by any suitable approach), and can control tilt of the fluid interface 15 in response to that OIS input information. In some cases, the lens tilt can be used for purposes other than OIS, such as for off-axis imaging. By way of example, the camera system 200 can zoom into a portion of the image that is not located at the center of the image. Controlling the tilt of the fluid interface 15 of the liquid lens 10 can, at least in part, be used to control the direction and amount of offset from center for the optical zoom. Although, not shown in FIG. 5, various embodiments disclosed herein can include two liquid lenses, such as for implementing an optical zoom function. The controller 206 can receive focal direction input information (e.g., for OIS or off-axis imaging), and can control tilt of the fluid interface 15 in response to that focal direction input information.

The controller 206 can receive optical power information. The input optical power information can include a target optical power (e.g., diopters) a target focal length, or other information that can be used to determine the curvature for the fluid interface 15. The optical power information can be determined by an autofocus system 222 of the camera system 200, can be set by input from a user (e.g., provide to a user interface of the camera system 200), or provided from any other source. In some embodiments, the controller 206 can determine the optical power information. For example, the controller 206 can be used to implement the autofocus system that determines a desired optical power or focal length. In some cases, the controller 206 can receive the optical power information and can determine a corresponding optical power for the liquid lens 10, for example since the other optical elements 204 can also affect the optical power (e.g., statically or dynamically). The controller 206 (e.g., using the processor 208) can then determine driver signal(s) (e.g., voltages) for the electrode(s) to control the curvature of the fluid interface 15. In some cases, the controller 206 can determine the driver signal(s) directly from autofocus data or directly from optical power information, such as without determining a value for the optical power of the liquid lens and/or without determining any other intermediate values.

The controller 206 (e.g., using the processor 208) can use the focal direction information (e.g., OIS information, orientation information, shake information, etc.) and the focal length information (e.g., optical power information, autofocus information, etc.) together to determine the driver signal(s) for the liquid lens 10. For example, the driver signals to produce 1 degree of optical tilt and 3 diopters of optical power can be different than the driver signals to produce 1 degree of optical tilt and 5 diopters of optical power. Various lookup tables 214, formulas, equations, and/or algorithms can be used to determine the driver signals based on both the focal length information and the focal direction information.

In some embodiments, the controller 206 can receive feedback and can drive the liquid lens 10 based at least in part on the feedback. The controller 206 can use a closed loop control scheme for driving the liquid lens 10. In some embodiments, the one or more sensors 224 can provide information to the controller, such as information regarding the fluid interface 15 position in the liquid lens 10. The sensors 224 can provide information regarding the fluid interface position for each of the insulated electrodes 22a-d. For example, the sensor 224 can provide a feedback signal that is indicative of the capacitance between the corresponding insulated electrode 22a-d and the first fluid 14. In some embodiments, the controller 206 can use a PID control scheme, an open loop control scheme, feed forward control scheme, or any other suitable approach for controlling the liquid lens 10.

The controller 206 can receive zoom information from a zoom system 226. The zoom information can include user input, such as a command for an amount of zoom. The zoom information can be determined by any other suitable manner, and from any other suitable source. The zoom information can be used to determine a focal length for one or more liquid lenses 10, and/or a position for one or more movable lens elements. The zoom information, can be used with the autofocus information, and/or with optical image stabilization information to determine parameters for the camera system 200 such as the liquid lens focal power, liquid lens tilt, position of a movable lens element, etc.

In some embodiments, the liquid lens 10 and other electrowetting devices disclosed herein can be used in systems other than a camera system 200, such as an optical disc reader, an optical fiber input device, a device for reading output from an optical fiber, an optical system for biological measurement (e.g., inducing fluorescence in a biological sample), endoscopes, an optical coherence tomography (OCT) device, a telescope, a microscope, other types of scopes or magnifying devices, etc. Many of the principles and features discussed herein can relate to liquid lenses 10 and/or electrowetting devices used in various contexts. A liquid lens system can include a liquid lens 10 and a controller 206 for controlling the liquid lens. An electrowetting system can include an electrowetting device and a controller 206 for controlling the electrowetting device. In some embodiments, various camera elements, such as the imaging sensor 202, autofocus system 222, orientation sensor 220, and/or other optical elements 204 can be omitted. In some implementations, the liquid lens 10 can be omitted. The optical elements 204 can include any suitable electrowetting device, or movable optical element, or active lens system disclosed herein, such as to implement auto focus, zoom, OIS, off-axis focus, or any combination thereof.

Movable Lens Elements

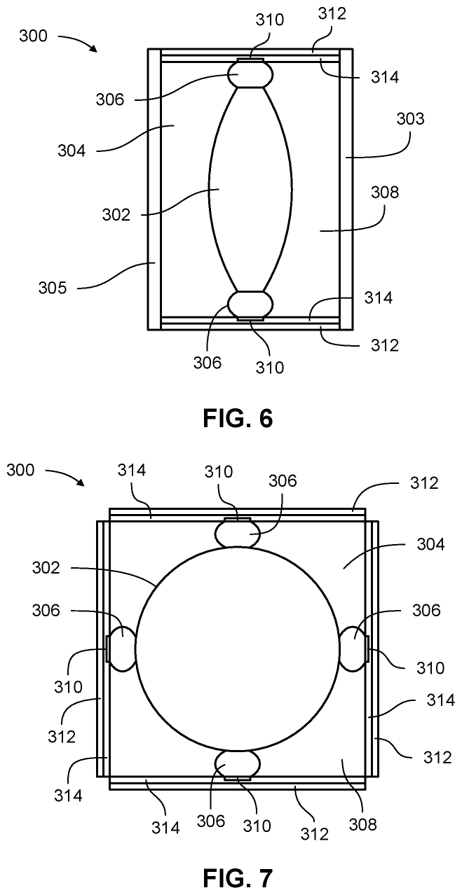

Camera systems and other devices can use one or more movable lenses, such as for implementing optical zoom and/or optical image stabilization. FIG. 6 is a cross-sectional view of an example embodiment of a movable lens system 300. FIG. 7 is cross-sectional view of the movable lens system 300, e.g., taken orthogonal to FIG. 6. The system 300 can include a lens element 302, which can be a solid lens, such as made of glass, plastic, or any other suitable lens material. The lens element 302 can be a biconvex lens (e.g., as shown in FIG. 6), a plano-convex lens, meniscus lens (e.g., converging or diverging), a plano-concave lens, a biconcave lens, a Fresnel lens, a diffraction grating, microlens array, ball lens array, liquid lens, active lens, variable focus lens, deformable lens, or any other suitable lens shape or type, or combinations thereof. Although various embodiments discussed herein use lens element 302, other optical elements could also be used, such as a mirror, a prism, light turning features, a light guide, or any other optical feature. Although various embodiments are shown or discussed herein in connection with a particular type of lens shape, other lens types or shapes can be used, such as depending on the particular application or other optical components of the system. The lens element 302 can be an active lens (e.g., a liquid lens), which can change in shape, optical power, etc. The lens element 302 can be disposed inside of a chamber 304, which can be defined by a housing. The housing can enclose the chamber 304. The chamber 304 and/or housing can be sealed, which can impede fluid from escaping and/or evaporating. A front window 303 and a back window 305 can transmit light through the housing and through the lens element 302.

The chamber can contain a first fluid 306, which can suspend the lens element 302 in the chamber 304. The first fluid 306 can be a polar fluid, an electrically conductive fluid, an aqueous solution, and/or water. The chamber can contain a second fluid 308, which can be substantially immiscible with the first fluid 306, such as to form a fluid interface where the first fluid 306 and the second fluid 308 meet. As discussed herein, in some cases a membrane or other dividing structure or material can separate the first fluid 306 from the second fluid 308, such as to provide the fluid interface. The second fluid 308 can be an electrically insulating material such as an oil. In some cases the second fluid 308 can be air or another gas. One or more fluid bodies (e.g., drops) of the first fluid 306 can be coupled to the lens element 302 and to the housing, such as to suspend the lens element 302.

The lens element 302 can be treated so that one or more first fluid contact areas of the lens element 302 have higher wettability for first fluid 306 than other areas. The lens element 302 can be treated so that one or more second fluid contact areas of the lens element 302 have higher wettability for the second fluid 308 than other areas. The inner surface of the housing can have one or more first fluid contact areas that have higher wettability for the first fluid 306, and one or more second fluid contact areas that have higher wettability for the second fluid 308. For example, a hydrophilic material can be applied (e.g., coated) to first fluid contact areas. The first fluid contact areas can be distributed about a periphery or edge of the lens element 302 and on corresponding locations on the inner surface of the housing. In some cases, a hydrophobic material can be applied (e.g., coated) onto portions of the lens element 302 and/or housing, but not onto the first fluid contact areas. In some embodiments, an oleophlic material can be applied (e.g., coated) to the second fluid contact areas. The second fluid contact areas can cover some or all of the front and/or back faces of the lens element, and can cover some or all of the area between the first fluid contact areas around the periphery or edge of the lens element 302. The second fluid contact areas can cover the inner surface of the housing between the first fluid contact areas. In some cases, an oleophobic material can be applied (e.g., coated) onto portions of the lens element 302 and/or housing, but not onto the second fluid contact areas.

When in the undriven state, the first fluid 306 can substantially cover the first fluid contact areas, and the second fluid 308 can substantially cover the second fluid contact areas. The undriven state is shown in FIGS. 6 and 7. The fluid bodies of the first fluid 306 can suspend the lens element 302 in the chamber 304. The wetting properties of the first and second fluid contact areas can impede the first fluid bodies from moving about in the chamber 304, and the lens element 302 can be tethered to the first fluid bodies by the wetting properties. The system can include four fluid bodies of the first fluid 306, although any other suitable number of fluid bodies can be used (e.g., 2, 3, 4, 6, 8, 12, 16, 32, or more, or any values therebetween). FIG. 9 shows an example that has eight fluid bodies of the first fluid 306. Additional fluid bodies can provide more control over the movement of the lens element 302.

The system 300 can include one or more first electrodes 310, which can be in electrical communication with the first fluid 306. The electrodes 310 can physically contact the first fluid 306, or they can be capacitively coupled. The system 300 can include one or more second electrodes 312, which can be insulated from the first fluid 306 and/or the second fluid 308 by an insulating material 314. The insulating material 314 can have higher wettability for the second fluid 308 than for the first fluid 306. The insulating material 314 can be parylene. In some embodiments, the material of the first electrodes 310 can have higher wettability for the first fluid 306 than for the second fluid 308. The material of the first electrodes 310 can have higher wettability for the first fluid 306 than the insulating material 314.

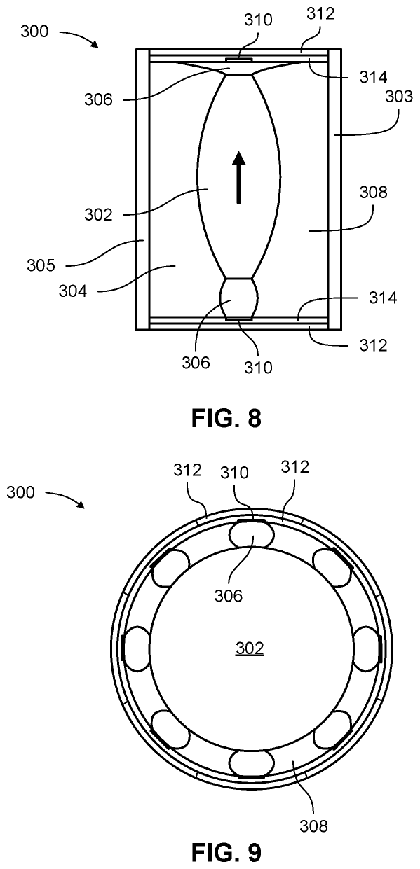

Voltage differentials can be applied between the sets of first electrodes 310 and second electrodes 312 to move the lens element 302. For example, the voltages can control lateral movement of the lens element 302, such as in directions orthogonal to the optical axis or axis of rotational symmetry of the lens element, of the housing, or of other optical components (e.g., in the lens stack). FIG. 8 shows can example in which a higher voltage differential is applied between the upper first electrode 310 and the upper second electrode 312 than between the lower first electrode 310 and the lower second electrode 312 (e.g., no voltage applied to the lower electrode set), which can cause the lens element 302 to move upward. The voltage differential applied between the upper set of electrodes can modify the shape of the upper first fluid body. The voltage differential can cause the first fluid 306 to wet the surface of the surrounding second fluid contact area. In the undriven state, the first fluid 306 can be substantially constrained to the first fluid contact area, which in some cases can cause the first fluid 306 to bead up. As the applied voltage differential increases, the first fluid 306 can spread out over the surface. The applied voltage differential can modify the wettability of the surface based on the principle of electrowetting. The increasing voltage can increase the contact area of the first fluid with the inner housing surface.

Voltage differentials can be applied to the sets of electrodes in different combinations and different amounts to control the direction and amount of movement of the lens element 302. By way of example, driving the lower set of electrodes and the right set of electrodes can cause the lens element to move downward and to the right. If more voltage were applied between the right electrodes, then the lens element would move more to the right than downward. The lens element 302 can be moved (e.g., laterally) to implement optical image stabilization. Shaking of the lens or camera system can be compensated for by moving (e.g., oscillating) the lens element 302. FIG. 9 shows a movable lens system with eight sets of electrodes, which can enable more control over the movement of the lens element 302. Also, the cavity can be cylindrical (e.g. FIG. 9), or rectilinear (e.g., FIG. 7), or any other suitable shape.

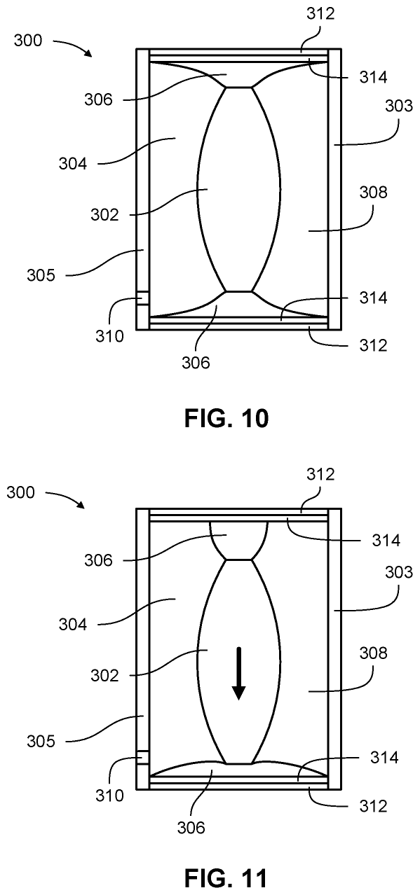

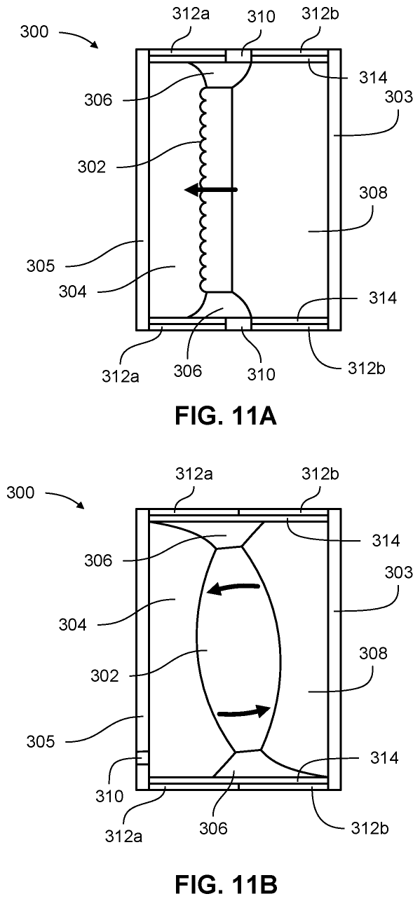

Many variations and alternatives are possible. For example, FIG. 10 shows an example embodiment of a movable lens system, which can be similar to the embodiments of FIGS. 6 to 9. The first fluid 306 can be an electrically insulating fluid, such as an oil. The second fluid 308 can be a polar fluid, an electrically conductive fluid, an aqueous solution, or water. The inner surface of the housing (e.g., the insulating layer) can be hydrophobic and/or oleophylic, which can cause the first fluid to spread out across the surface (e.g., of the first fluid contact area), in the undriven state. The first electrode 310 can be in electrical communication with the second fluid 308. As shown in FIG. 11, when a voltage differential is applied (e.g., an RMS voltage), the second fluid 308 can be driven into the first fluid contact area (e.g., by electrowetting). The voltage can decrease the area of contact between the first fluid and the inner housing surface. This can cause the first fluid to raise in height and can push the lens element 302 away. Accordingly, in FIG. 11 a voltage differential can be applied to the upper set of electrodes to move the lens element 302 laterally downward.

In some embodiments, the lens element 302 (or other optical element) can be moved axially and/or can be tilted (e.g., relative to the optical axis or structural axis or axis of symmetry). FIG. 11A shows an example embodiment of a movable lens system 300, which can have features similar to the embodiments of FIGS. 6-9. In FIG. 11A, the lens element 302 is shown as a microlens array, although any suitable optical element could be used. Similarly, the microlens array could be used for any of the lenses or optical elements disclosed herein. The microlens array shown may not be to scale, although all dimensions shown are considered part of this disclosure. Any size, number, and/or distribution of microlens elements can be used for the microlens array. In FIG. 11A, the system 300 can have one or more first electrodes 312a, which can be positioned generally on a first side of the lens element 302 (e.g., forward of the lens element 302), and one or more second electrodes 312b, which can be positioned generally on a second side of the lens element 302 (e.g., rearward of the lens element 302). The first one or more electrodes 312a can be driven differently than the corresponding second one or more electrodes 312b in order to drive the lens element 302, or corresponding portions thereof, in the first direction (e.g., forward) and/or in the second direction (e.g., rearward). The first electrodes 312a and be insulated from the second electrodes 312b. In some cases, a plurality of the fluid bodies 306 (e.g., each of the fluid bodies 306) can have an associated first electrode 312a and an associated second electrode 312b. The different fluid bodies 306 can be driven together (e.g., for axial movement of the lens element 302), and/or can be driven differently (e.g., for tilting of the lens element 302). The one or more electrodes 310 (e.g., a common electrode), can be between the corresponding first electrode 312a and second electrode 312b, and can be insulated therefrom.

In an undriven state, the lens element 302 can be positioned similar to FIG. 6. Driving the first electrodes 312a and not the electrodes 312b can cause the lens element 302 to move (e.g., axially) in the direction of the first electrodes 312a. In some cases, similar movement can be accomplished by driving both the first and second electrodes 312a, 312b, but to different voltage differentials (e.g., with a larger voltage differential applied via the first electrodes 312a than via the second electrodes 312b). Applying the voltage differential via the electrodes 312a can change the wetting properties of the material 314 and/or can cause the fluid bodies 306 to migrate onto the material 314 (e.g., which can be hydrophobic) by electrowetting. In some cases, each of the first electrodes 312a can be driven to apply the same first voltage differential with the corresponding fluid bodies 306, while each of the second electrodes can be driven (or not driven) to apply the same second voltage differential (or lack thereof) with the corresponding fluid bodies 306.

Lateral movement of the lens element 302 (e.g., similar to FIG. 8) can be achieved by driving some pairs of the first and second electrodes 312a, 312b differently than others. For example, if voltage differentials (e.g., substantially equal voltage differentials) were applied between the fluid body 306 (e.g., via the electrode 310) and both of the first and second electrodes 312a, 312b on the top side of FIG. 11A, while the first and second electrodes 312a, 312b on the bottom of FIG. 11B were not driven, the lens element 302 can move laterally (e.g., upward in FIG. 11A), similar to FIG. 8. The fluid body 306 at the top of FIG. 11A can spread out over the material 314 over both the upper first and second electrodes 312a, 312b. The fluid body 306 at the bottom of FIG. 11A can remain repelled off of (or biased away from) the material 314 in the undriven state. In some cases, the bottom first and second electrodes 312a, 312b, could be driven (e.g., but to lower voltage differentials than the top), to produce similar lateral movement of the lens element 302. Although not shown in FIG. 11A, intermediate sets of electrodes 312a, 312b, 310 could be driven to intermediate voltage differentials, or can be undriven, to facilitate movement of the lens element 302.

The electrodes 312a, 312b can be used to tilt the lens element 302. For example, the upper set of first and second electrodes 312a, 312b can be used to drive the upper side of the lens element 302 in a first direction, while the lower set of first and second electrodes 312a, 312b can be used to drive the lower side of the lens element 302 in a second direction. For example, a voltage differential can be applied to the upper first electrode 312a, such as to drive the upper side of the lens element 302 toward the first electrode 312a (e.g., forward). And a voltage differential can be applied to the lower second electrode 312b, such as to drive the lower side of the lens element 302 toward the second electrode 312b (e.g., rearward), similar to the lens element 302 in FIG. 11B. In some case, substantially the same voltages can be applied to opposing first and second electrodes 312a, 312b so that the tilting of the two sides of the lens element 302 is substantially symmetrical. In some cases, different voltages can be applied to the opposing first and second electrodes 312a, 312b, or one can be left undriven, which can cause the lens element 302 to tilt, and in some cases can also cause the center of the lens element to shift axially as well.

Many variations are possible. FIG. 11B shows an example embodiment of a movable lens system 300, which can have features similar to the embodiments of FIGS. 10 and 11. The embodiment of FIG. 11B can have one or more first electrodes 312a and one or more second electrodes 312b, similar to FIG. 11A. In the embodiment of FIG. 11B, the lens element 302 can be moved axially, laterally, or tilted similar to the embodiment of FIG. 11A, except that the fluid bodies 306 (e.g., first fluid) in FIG. 11B can be the insulating fluid (e.g., oil), while the second fluid 308 can be the conductive fluid. Accordingly, the position of the electrode 310 can be moved to have electrical communication with the second fluid 308, and in some cases a single electrode 310 can be used. Also, in FIG. 11B, the voltage differentials can be applied to drive the lens element 302, or associated portion thereof, away from the driven electrode(s), rather than pulling it towards the driven electrode(s).

In some embodiments, a third fluid (not shown) can be contained in the chamber. For example, an air gap, or other gas or liquid, can be contained in the chamber, such as along an optical path through the device, which can increase the refractive index difference as light enters or exits the lens element 302. This can reduce the amount of movement needed for the lens element 302, which can improve response speed, reduce optical aberrations, and increase visual quality.

Although FIG. 11A shows and example of only axial movement, and FIG. 11B shows an example of only tilt movement, the systems 300 of FIGS. 11A and 11B can be configured to provide any combination of available axial, lateral, and tilting movements. The controller 206 can provide control signals to move the lens element 302 in order to implement autofocus, optical zoom, OIS, off-axis focus, other focus changes, or any combination thereof (e.g., simultaneously), such as in response to the orientation sensor 220, zoom system 226, and/or autofocus system 222, or any other suitable input or parameters.

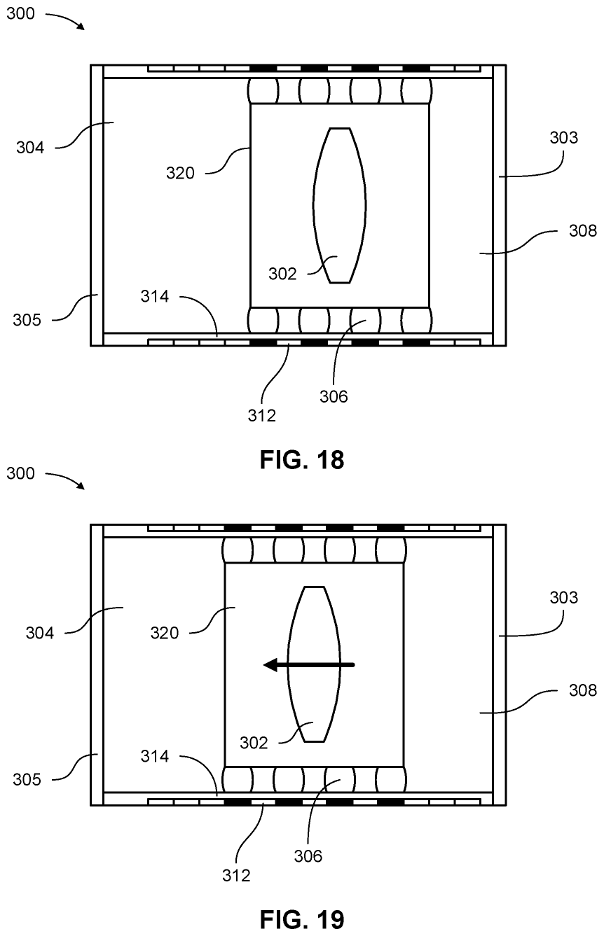

In some embodiments, the systems 300 can move the lens element 302 with five degrees of freedom. Oriented so that movement to the left in the illustrated embodiments is forward, the lens element 302 can be moved with forward/back, up/down, right/left, pitch, and yaw motion. In some cases, the system 300 does not move the lens element with roll motion (e.g., rotated about the optical axis, axis of symmetry, or structural axis). However, in some embodiments, electrodes can be positioned along the periphery or circumference so that the fluid bodies 306 can be moved between neighboring electrodes in order to enable roll movement of the lens element 302 as well, such as similar FIGS. 18-22 and 30-33. Accordingly, in some embodiments, the system can move the lens element 302 with six degrees of freedom. In some embodiments, only two degrees of freedom are available, such as for embodiments that only are capable of lateral movement of the lens element 302 (e.g., right/left and up/down movement). In some embodiments, only one degree of freedom is available, such as if only axial movement is available (e.g., front/back movement). In some cases, three degrees of freedom are available, such as if the system can move the lens element for tilt and axial movement only. Many iterations of available lens element motion are possible.

In some cases, OIS can be implemented using one or both of tilt and lateral movement of the lens element 302. For example, displacement OIS can be implemented by laterally moving the lens element 302, which can have a corresponding shift of the resulting image and/or can change the focal direction of the system 300. Tilt OIS can be implemented by tilting the lens element 302, which can change the focal direction of the system 300. OIS can be implemented using both tilt and lateral movement simultaneously. The flexibility of movement available can enable OIS, or off-axis focus, with reduced or eliminated field curvature. Autofocus or other changes of focal length can be implemented using at least the axial movement of the lens element 302. In some cases, a zoom function can be implemented at least partially using axial movement of the lens element 302. In some cases, two or more movable lens systems can be used to implement optical zoom.

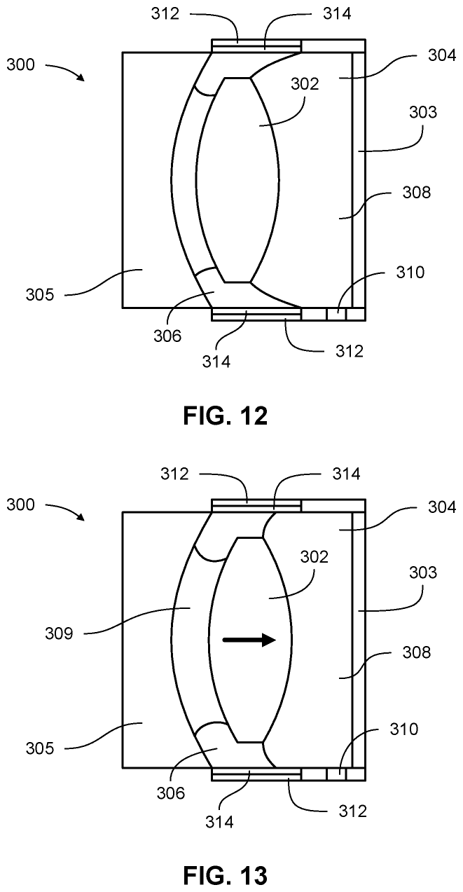

FIG. 12 is a cross-sectional view of an example embodiment of a movable lens system 300, which can have features similar to the embodiments of FIGS. 6 to 11. In some embodiments, a lens element 302 can be moved axially, such as by electrowetting. Axial movement of the lens element 302 can be used to implement optical zoom. The window 305 can be contoured to substantially conform to the shape of the lens element 302 facing the window 305. In some embodiments, the window 305 can be substantially flat, or have any other suitable shape. The first fluid contact areas can position a portion of the first fluid 306 between the lens element 302 and the window 305. For example, the first fluid 306 can be oil, the second fluid 308 can be an aqueous solution, and a hydrophobic material (e.g., parylene) can coat portions of the periphery of the window 305 (e.g., the areas in FIG. 12 that are in contact with the first fluid 306). Corresponding portions of the periphery of the lens element 302 (e.g., on the periphery of the lens face and/or on the edge of the lens element) can also be coated with the hydrophobic material. The first fluid 306 can spread across first fluid contact areas on the sidewalls of the inner surface of the housing, and one or more second electrodes 312 can be disposed under those second fluid contact areas. The second electrodes 312 can be insulated from the fluids by an insulating layer 314, which can be hydrophobic (e.g., parylene) in this example. One or more first electrodes 310 can be in electrical communication with the second fluid 308.

Applying a voltage differential between the first electrode 310 and the second electrode 312 can cause the second fluid to encroach into the first fluid contact area. This can displace the first fluid 306 and drive the first fluid 306 into the space between the lens element 302 and the window 305. Increasing the amount of the first fluid 306 between the lens element 302 and the window 305 can move the lens element 302 (e.g., axially away from the window 305) as shown in FIG. 13. As the voltage (e.g. RMS voltage) is increased, more of the first fluid is driven behind the lens element 302 to push the lens element 302 farther (e.g., in the axial direction).

In some embodiments, the first fluid 306 can form a continuous fluid body that extends around the periphery of the lens element 302 and/or housing inner surface. The electrode 312 can be a single ring electrode. When a voltage is applied, it can be substantially uniformly applied about the periphery so that the lens element 302 is driven axially without tilting. In some cases, the area between the lens element 302 and the window 305 that is bounded by the body of the first fluid 306 can be filled with air or another suitable fluid (e.g., a gas). Pushing the lens element 302 (e.g., axially) can cause that area to change in volume (e.g., expand). In some cases, it can require additional voltage to provide the force to change (e.g., expand) the volume of this area. The lens element 302 can have the second fluid (e.g., an aqueous solution in this example) on one side and a different fluid 309 (e.g., air or another gas in some examples), which can be isolated from each other by the first fluid (e.g., oil in this example). The air or other fluid/gas can provide for a larger refractive index difference at the transition between the lens element 302 to the air or other fluid/gas, as compared to transitioning between the lens element 302 and the second fluid 308. This can provide the benefit that less motion of the lens element 302 can be used to produce the optical changes (e.g., for OIS, optical zoom, or autofocus).

In some embodiments, the area between the lens element 302 and the window 305 can be in fluid communication with the area between the lens element 302 and the window 303. As the lens element 302 moves, a portion of the second fluid 308 can move around the lens element, which can impede pressure from building on one side of the lens element 302. The first fluid 306 can form a plurality of fluid bodies (e.g., drops). The fluid bodies can be distributed about the periphery of the lens element 302 and corresponding locations on the housing inner surface and/or window 305. The distribution can be somewhat similar to FIG. 7 or FIG. 9. The spaces between the fluid bodies of the first fluid 306 can permit the second fluid to flow past the lens element 302, for example as the lens element 302 moves.

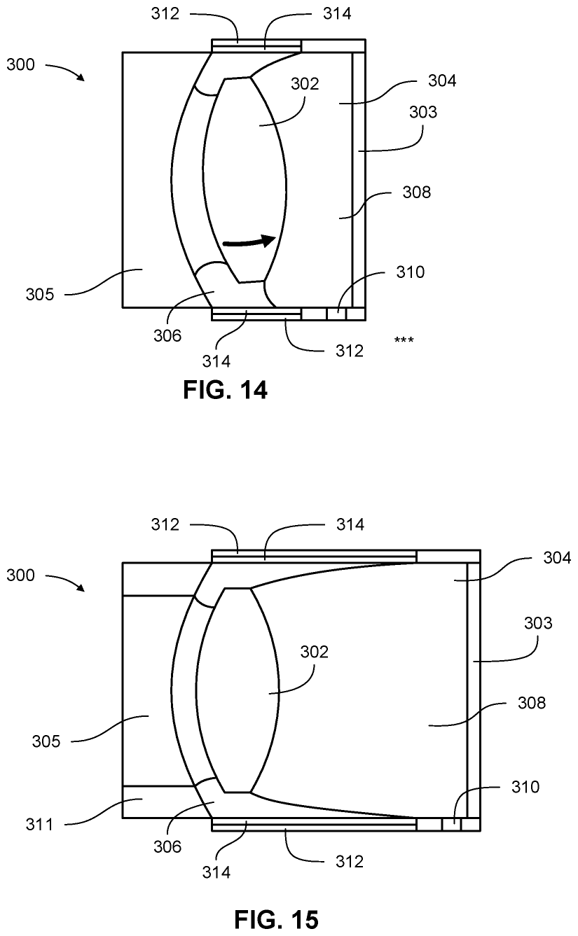

With reference to FIG. 14, the electrodes 312 can be driven at different voltages to tilt the lens element 302. In the example of FIG. 14, the upper electrode 312 does not receive a voltage while the lower electrode 312 receives a voltage to form a voltage differential between the lower electrode 312 and the second fluid 308 (e.g., via the electrode 310). This can cause the second fluid 308 to displace the first fluid on the lower area, which can cause the lower side of the lens element 302 to move (e.g., axially) Since the lower side of the lens element 302 moves axially while the upper side of the lens element 302 does not move (or moves by a lesser amount), the lens element 302 can tilt. The lens element 302 can also move laterally, in some embodiments. For example, in FIG. 14 the displaced first fluid 306 on the bottom can push the lens upward.

Many variations and alternatives are possible. With reference to FIG. 15, the range of motion for the lens element 302 can be increased by increasing the size (e.g., axial length) of the housing and/or by increasing the amount of the first fluid, which can be displaced to the area between the lens element 302 and the window 305 to push the lens element 302. In some cases, the first fluid 306 can be displaced into an area between the lens element 302 and a portion 311 of the housing (e.g., which can surround the window 305), or other structure, to push the lens element 302 (e.g., axially), as shown in FIG. 15. The inner surface of the portion 311 of the housing can have relatively higher wettability for the first fluid 306 (e.g., as compared to the window 305 or another more central region).

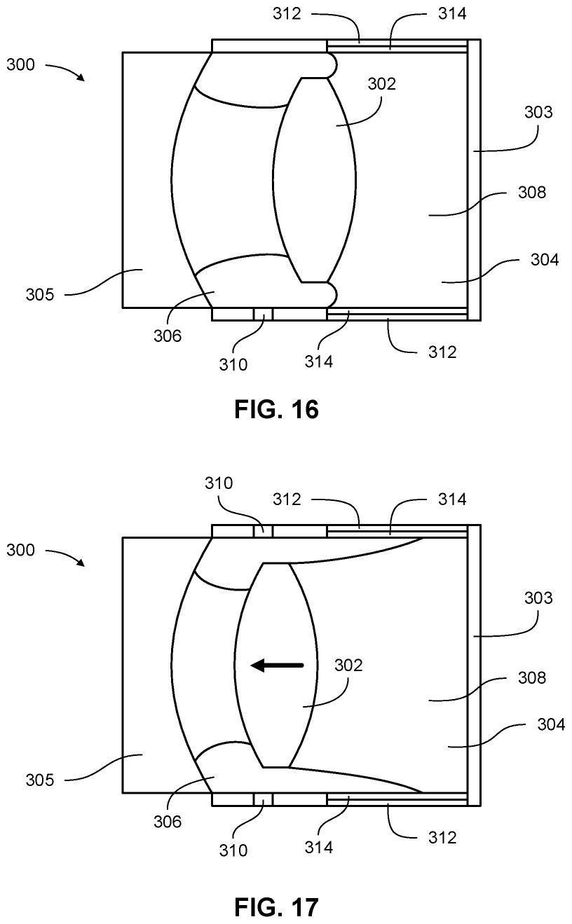

With reference to FIGS. 16 and 17, in some cases the first fluid 306 can be electrically conductive, a polar fluid, an aqueous solution, and/or water. The second fluid 308 can be insulating (e.g., oil). The wetting properties of the chamber 304 and the lens element 302 can cause the first fluid 306 to accumulate between the lens element 302 and the window 305 or a portion 311 of the housing. For example, a window 305 or central portion thereof have a hydrophobic material (e.g., coated thereon). A central portion of the lens element 302 can have a hydrophobic material (e.g., coated thereon). One or more areas over the electrode(s) 312 can by hydrophobic. As a voltage differential is applied between the electrode 312 and the first fluid, the first fluid can be pulled out from behind the lens element 302 and onto the area over the electrode 312, which can cause the lens element to move (e.g., axially towards the window 305). The first fluid 306 can be a continuous fluid body, which can isolate the area behind the lens element 302, in some cases. The first fluid 306 can include multiple fluid bodies, which can enable the second fluid 308 to flow around the lens element 302. In some cases a plurality of electrodes 310 can be positioned to be in electrical communication with the distinct fluid bodies of the first fluid 306. The different sets of electrodes can be driven at different voltages to tilt and/or laterally move the lens element 302 (e.g., similar to the discussion of FIG. 14).

In some embodiments, the lens element 302 (e.g., of any one of FIGS. 6 to 16) can be incorporated into a moving inner housing (e.g., similar to the inner housing 320 discussed herein). FIGS. 6 to 16 show a lens element 302 that is directly moved (e.g., by electrowetting). An inner housing can have materials, coatings, and shapes so that the housing can move similar to the embodiments discussed in connection with FIGS. 6 to 16, and the housing can hold the lens element 302. In some embodiments, the examples of FIGS. 6 to 16 can be modified to have a moving liquid lens 10 (e.g., according to FIGS. 1 to 4) in place of the solid lens element 302. Driving signals can be delivered to the liquid lens 10 by induction, similar to other embodiments discussed herein. In some cases, a camera system can change the focal length using a liquid lens 10 while the liquid lens 10 is moving (e.g., axially) to perform optical zoom (e.g., while maintaining a focal length for the lens system).

FIG. 18 is a cross-sectional view of an example embodiment of a movable lens system 300, which can have features similar to the other embodiments disclosed herein (e.g., relating to FIGS. 6 to 17). An outer housing can form a chamber 304, and an inner housing 320 can be positioned inside the chamber 304. The inner housing 320 can include a lens element 302, although other lenses and optical components can be included, as discussed herein. The inner housing 320 can have a circular cross-sectional shape, which can enable the inner housing 320 to rotate (e.g., about an axis, such as an optical axis) within the chamber 304. The chamber 304 can have a corresponding circular cross-sectional shape, which can be slightly larger. In some embodiments, the inner housing 320 can have a square cross-sectional shape, or any other suitable polygon or other non-rotationally-symmetrical shape, which in some cases can impede the inner housing 320 from rotating within the chamber 304. The chamber 304 can have a corresponding square cross-sectional shape, or any other shape that corresponds to the shape of the inner housing 320. In some implementations, the inner housing 320 can be omitted, and the lens element 302 can be moved directly. For example, the first fluid 306 can contact first contact areas disposed directly on the lens element 302.

The inner housing 320 can have one or more first fluid contact areas, which are shown covered by the first fluid 306 in FIG. 18. In some embodiments, the first fluid contact areas and corresponding fluid bodies of the first fluid 306 can extend continuously around the inner housing 320, (e.g., having a generally annular or toroidal shape). In some embodiments, the first fluid contact areas can be separate, and distinct fluid bodies of the first fluid 306 can be coupled to the inner housing 320 (e.g., due to the wetting properties). In FIG. 18, four fluid bodies of the first fluid are coupled to a top of the inner housing 320 and four fluid bodies of the first fluid 306 are coupled to a bottom of the inner housing 320. In some cases, additional fluid bodies can be coupled to the inner housing 320, such as on the sides thereof, and/or at other locations that are not on the cross-sectional plane of FIG. 18. The system can pull on the fluid bodies of the first fluid 306 to move the inner housing 320 (e.g., axially). Using more fluid bodies attached to the inner housing 320 can enable the system to move the inner housing 320 more rapidly and/or with more precision. The inner housing 320 can have 1, 2, 3, 4, 6, 8, 10, 12, 16, 20, 24, 32, 36, 40, or more fluid bodies of the first fluid 306 coupled thereto, or any values or ranges therebetween, although other designs are possible. In some embodiments, the inner housing 320 can be omitted, and the approach of FIGS. 18 to 19 can be applied to move a lens element 302 without a moving housing (e.g., similar to FIGS. 6 to 17). In some implementations, different voltages can be applied to different electrodes to move the inner housing 320 and/or lens element 302 laterally or to a tilted position, similar to other embodiments discussed herein.

The first fluid contact areas on the inner housing 320 and/or the fluid bodies of the first fluid 306 can align with a plurality of electrodes 312, which can be insulated from the fluids (e.g., by insulating material or layer 314). The electrodes 312 can be arranged along a direction of travel for the inner housing 320. For example, the electrodes 312 can extend along a direction parallel to the axial direction. In the example of FIG. 18, the first fluid 306 can be a conductive fluid, a polar fluid, an aqueous solution, and/or water. The second fluid 308 can be an insulating fluid (e.g., an oil). The oil can surround the water, which can impede evaporation of the water. In some embodiments, the first fluid 308 and/or the second fluid 308 can be air, or another suitable gas, which can result in less damping as compared to using an oil or other liquid. The inner housing 320 can be moved more quickly and/or more efficiently using air or another gas as the second fluid 308. Also, using air can produce a higher refractive index difference when transitioning between materials, which can enable less motion to produce the desired optical effects, which can result in less optical aberration, such as less dispersion or less chromatic aberration.

The electrodes 312 can be driven with voltages to position and/or move the inner housing 320, such as by using digital microfluidics. In FIG. 18, the electrodes 312 shown in black can be driven with a voltage (e.g., an RMS voltage), while the electrodes 312 shown in white are not driven (or have a lower voltage). The insulating material 314 (e.g., parylene) or other material over the electrodes 312 can be hydrophobic. Driving the electrodes 312 with a voltage can overcome the hydrophobicity and cause the first fluid 306 to contact the surface (e.g., the insulating material 314) above the driven electrodes 312. The electrodes adjacent the driven electrodes can be undriven (or driven at a lower voltage), which can hold the first fluid at the areas above the driven electrodes.

With reference to FIG. 19, the inner housing 320 and/or lens element 302 can be moved by changing which electrodes 312 are driven. For example, the electrodes 312 that were driven in FIG. 18 can be changed to an undriven state, and voltages can be applied to the adjacent electrodes, which are shown in black in FIG. 19. This can cause the fluid bodies of the first fluid 306 to move (e.g., axially to the left in FIG. 19) so that the fluid bodies are positioned over the currently driven electrodes 312. This can be repeated to move the inner housing axially farther. The inner housing 320 can have distinct available positions, as opposed to some other embodiments disclosed herein, which can be infinitely positionable within a range of motion. The electrodes 312 can be insulated from each other. The fluid bodies of the first fluid 306 can be spaced apart, which can maintain the separate fluid bodies. The electrodes 312 can be closer together than the fluid bodies. For example, an undriven electrode 312 can be positioned between two fluid bodies of the first fluid 306. A larger range of motion can be provided by extending the size of the outer housing, and by extending the series of electrodes 312.

In some embodiments, the first fluid 306 is not charged, or no voltage is applied to the first fluid 306. The voltage differentials can be provided by the voltage applied to the electrodes 312. In some cases, the first fluid 306 bodies can be grounded. For example, a conductive material can contact the first fluid 306. The first fluid contact area(s) can have an exposed lead, which can be grounded. In some cases, voltages can be applied to the fluid bodies of the first fluid 306. For example, the inner housing 320 can have electrode(s), such as disposed inside the first fluid contact area(s) for applying voltage(s) to the first fluid coupled thereto. Electrical voltage can be coupled from the outer housing to the inner housing 320 by inductance (e.g., as discussed herein), and the voltage can then be directed through the inner housing to the electrode(s) and the first fluid 306.

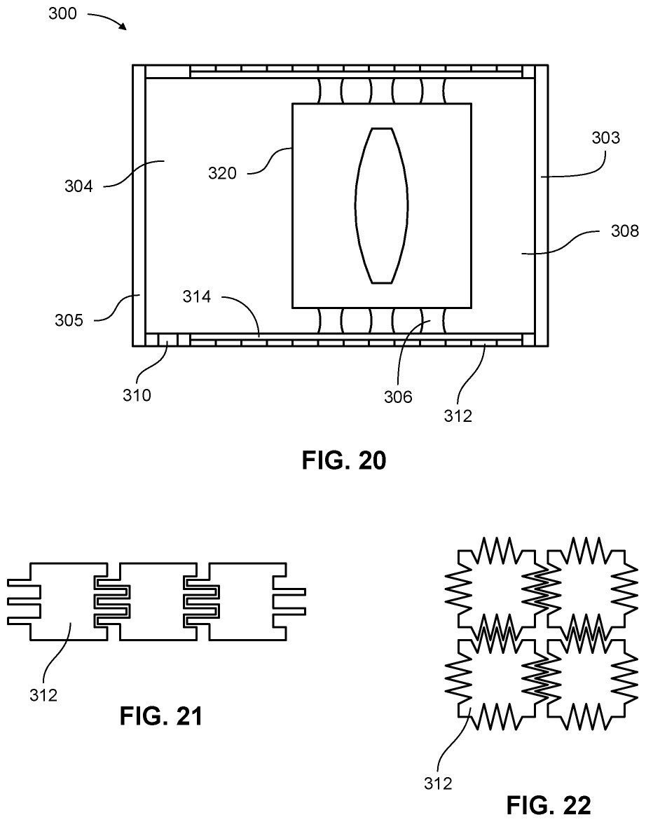

Many variations and alternatives are possible. FIG. 20 is an example embodiment of a movable lens system 300, which can be similar to the embodiment of FIGS. 18 to 19. The first fluid can be an insulating fluid, such as an oil. The second fluid 308 can be a conductive fluid, a polar fluid, an aqueous solution, or water. An electrode 310, such as on the outer housing can be in electrical communication with the second fluid 308. The first fluid 306 can form fluid bodies on the inner housing 320, such as coupling to hydrophobic or oleophylic material on the inner housing (e.g., parylene). The electrodes 312 can be covered by a hydrophobic material (e.g., parylene). When the electrodes 312 receive a voltage, the second fluid 308 can wet the area above the driven electrodes 312, as shown in FIG. 20. In FIG. 20, the three electrodes that are aligned with the fluid bodies of the first fluid 306 are not driven, while the rest of the electrodes 312 are driven with a voltage (e.g., RMS voltage), such as to overcome the hydrophobicity of the area above the driven electrodes. By changing which electrodes are driven, the system can move the fluid bodies of the first fluid 306, and the inner housing 320 that is coupled thereto, similar to the discussion in connection with FIG. 19. In some embodiments, the area above the electrodes 312 can include an oleophobic material or a hydrophilic material (e.g., TiO₂), and applying a voltage can alter the wetting properties of the area above the driven electrode(s), which can move the fluid bodies of the first fluid 306 and the inner housing 320 that is coupled thereto.

FIG. 21 is an example embodiment of electrodes 312, which can be used with various embodiments disclosed herein. The electrodes 312 can be interdigitated. The edges of the electrodes can have extensions and/or recesses. The extensions of one electrode can be received into the recesses of an adjacent electrode. When a voltage is transitioned from one electrode to an adjacent electrode, the extensions of the adjacent electrode can be closer to the movable fluid than the core of the electrode, and in some cases the movable fluid can overlap the extensions of adjacent electrodes when it is stationary over the currently driven electrode. This can enable the newly driven electrode to move the fluid more reliably, more quickly, and/or more efficiently. In FIG. 21, three interdigitated electrodes 312 are shown, although several others can be included in the series. In FIG. 21, the electrodes 312 are interdigitated in only one direction. For example, the upper and lower sides can be flat, or otherwise not interdigitated. In some cases, there may be no additional electrodes 312 adjacent to the upper and lower sides. In FIG. 22, the electrodes 312 can be interdigitated in both directions, and the electrodes can be arranged as an array. In some embodiments, the inner housing 320 can be moved rotationally (e.g., about an optical axis) as well as, or instead of, being movable axially. Various suitable shapes and patterns can be used for the edges of the electrodes, as shown for example in FIGS. 21 and 22.

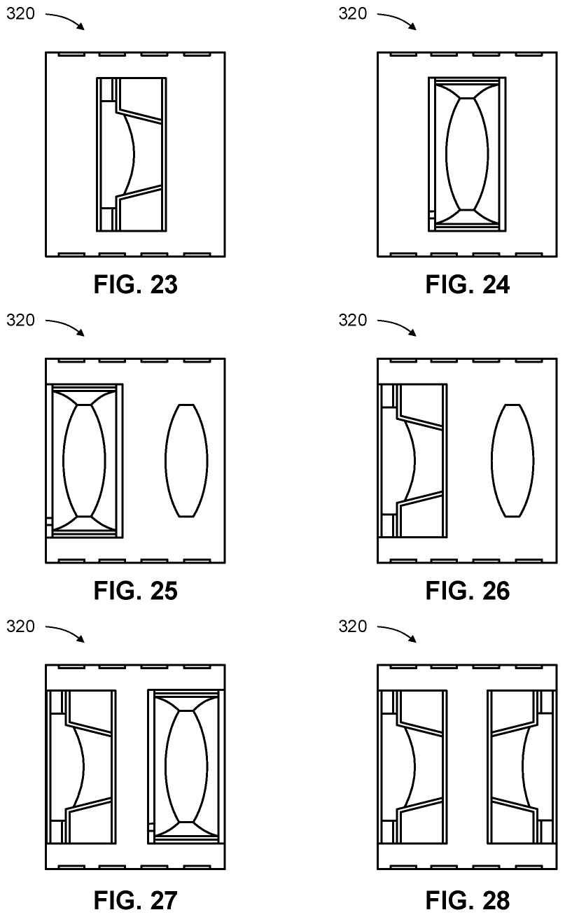

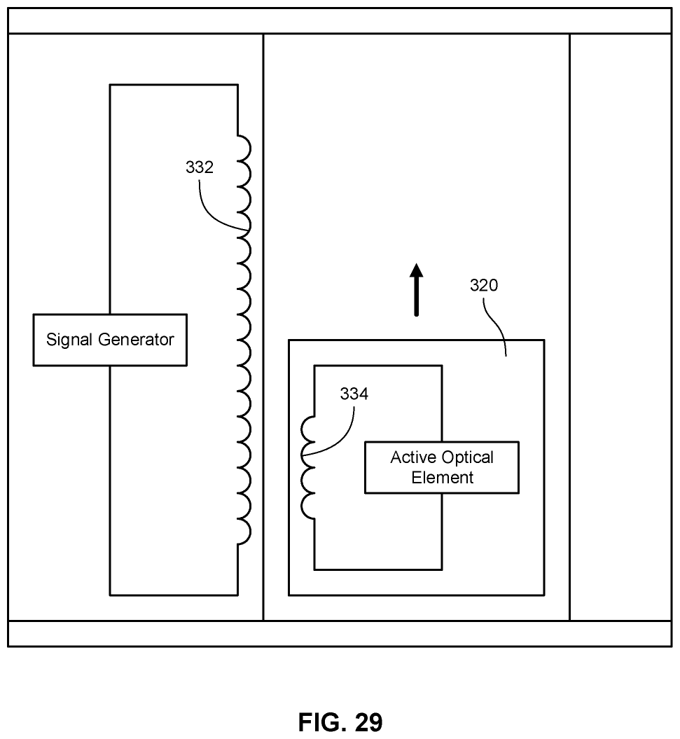

FIGS. 23 to 28 show example embodiments of an inner housing 320. The inner housing can have a solid lens element 302, as shown for example in FIGS. 18 to 20. The solid lens element 302 can be fixed relative to the inner housing 320. In FIG. 23, the inner housing 320 can have a liquid lens 10, which can be similar to the embodiments of FIGS. 1 to 4. The inner housing 320 can have a variable focus lens. The liquid lens 10 can alter the focal length (e.g., for autofocus or for maintaining focus while zooming) and/or the focal direction (e.g., for OIS and/or off-axis imaging). In FIG. 24, the inner housing 320 can have a movable solid lens. The inner housing 320 can have a movable lens according to any of the embodiments discussed in connection with FIGS. 6 to 17. The movable lens can tilt or move laterally, such as for OIS. In some embodiments, the inner housing 320 can include multiple lenses or multiple optical elements. In FIG. 25, the inner housing can include a movable lens (e.g., a movable solid lens) and one or more fixed solid lenses. In FIG. 26, the inner housing can have a liquid lens 10 and one or more fixed solid lenses. In FIG. 27, the inner housing can have a liquid lens 10 (e.g., for varying the focal length such as for autofocus and/or maintaining focus while zooming) and a movable lens (e.g., a movable solid lens), which can be movable to implement OIS. In FIG. 28, the inner housing can include two liquid lenses 10. One liquid lens 10 can be used to vary the focal length, while the other can vary the focal direction (e.g., for OIS), for example. In some cases the two liquid lenses can both vary the focal length, which in some cases can be used by the optical zoom system. Additional lens elements or other optical elements can be included. For example, the inner housing 320 can have any suitable number (e.g., 1, 2, 3, 4, 5, 6, 7, 8, or more) of lens elements or other optical elements, as appropriate for the particular application.

Various other permutations and combinations of optical elements can be include (e.g., in the inner housing 320) and can be movable, as appropriate for various camera systems and other optical systems. In some cases, a microlens array can be used. For example, the inner housing 320 can include a microlens array. In some cases, the microlens array can be used for OIS. The microlens array can be rotationally asymmetrical. The inner housing can be rotated about an axis, which can rotate the microlens array, to modify light that propagates through the inner housing and the microlens array. Various other optical elements (e.g., lenses) can be asymmetrical lenses (e.g., an astigmatism lens or anamorphic lens) that can be rotated about an axis to modify the light. In some embodiments, the microlens array can focus light onto the imaging sensor 202 (e.g., a CMOS or CCD sensor), either directly or with one or more intermediate lenses or other optical elements. Each microlens element can focus light onto a single pixel of the imaging sensor 202, or onto a group of pixels, or an area of the imaging sensor 202. A microlens array can be used to implement OIS, autofocus, focal length changes, off-axis focus, zoom, etc., as discussed herein. In some embodiments, the microlens array can be molded (e.g., from plastic, glass, or any suitable material). The mold can be aluminum, or high phosphor nickel aluminum, or any other suitable material. In some cases, the microlens array can be diamond turned. The microlens array can be molded, or otherwise made, to be very accurate.

In some embodiments, the inner housing 320 can include an active lens or other active optical element, which can move in some cases. The system can send one or more control and/or power signals from the outer housing to the inner housing 320, such as by induction. The inner housing 320 can direct the control and/or power signals to the active optical elements (e.g., by one or more wires or other conductive paths). The outer housing can include a first inductor coil 332. The inner housing 320 can include a second inductor coil 334. A signal generator (e.g., which can be part of the outer housing, the camera control system, etc.) can send control and/or power signals to the first inductor coil 332. Power and/or signals can be transferred, such as by induction, from the first inductor coil 332 to the second inductor coil 334. The power and/or control signals can be delivered from the second inductor coil 334 to the active optical element, such as for driving a liquid lens or for moving a solid lens (e.g., using electrowetting or any other manner disclosed herein or suitable approach). The first inductor coil 332 on the outer housing can be longer or larger than the second inductor coil 334 on the inner housing 320 (or vice versa), so that induction can occur when the inner housing 320 is at a variety of different positions. Additional inductor coils can be used to send a plurality of signals (e.g., for power and/or control) to the inner housing 320 and the associated active optical element(s). In some cases, shielding can be used to reduce interference between the multiple signals being transferred by inductance.

Power and/or control signals can be delivered to the inner housing 320 by any suitable system or technique. For example, in some embodiments a slip ring can be used. In some embodiments, a rotating transformer can be used. In some embodiments, a sliding transformer can be used. Many variations and alternatives are possible.

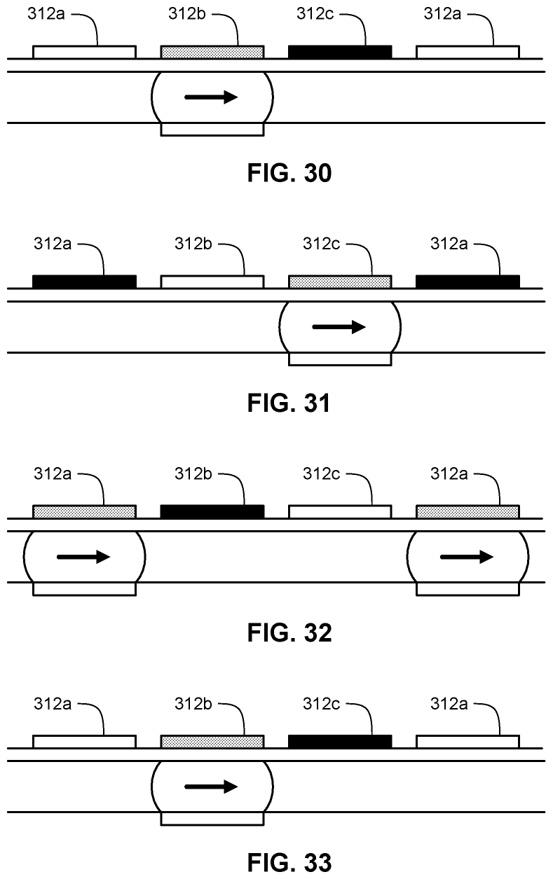

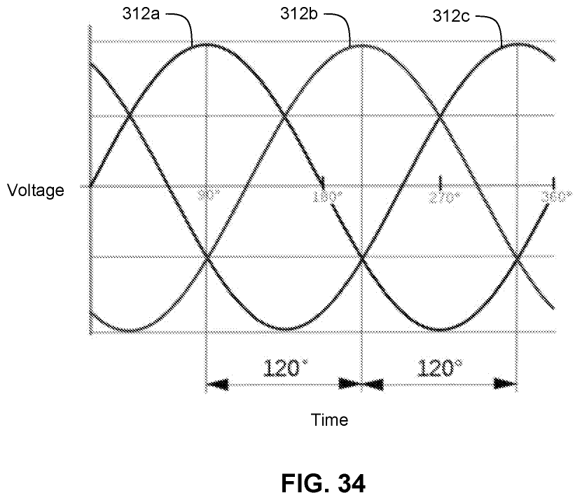

The electrodes 312 can be driven using various different approaches. FIGS. 30 to 34 illustrate an example approach for driving the electrodes 312. There can be three electrodes 312a-c for one fluid body (e.g., of the first fluid or of the second fluid). In FIG. 30, the electrode 312a can be at a low or zero voltage value (e.g., RMS voltage) shown in white, which can cause the area at the electrode 312a to be hydrophobic for pushing the fluid body forward. The electrode 312b can be at a mid-range voltage shown in grey as the fluid body crosses the electrode 312b, for example, so that the area at the electrode 312 is relatively neutral. The electrode 312b can be transitioning from pulling to pushing the fluid body, for example. The electrode 312c can have a relatively high voltage value shown in black, which can cause the area at the electrode 312c to be relatively hydrophilic, which can pull the fluid body forward towards the third electrode. As can be seen in FIGS. 31 and 32, as the fluid body advances to the electrode 312b and then 312c, the voltage values for the electrodes 312a-c can change so that the one or more electrodes in advance of the fluid body can pull the fluid body forward, and/or so that the one or more electrodes behind the fluid body can push the fluid body forward. At FIG. 33, the inner housing 320 has advanced so that a next fluid body is aligned with the electrode 312b, similar to FIG. 30. As the inner housing 320 advances, the voltages for the three electrodes 312a-c can be driven 120 degrees out of phase with each other, as show in FIG. 34. FIG. 34 shows a sinusoidal voltage signal, but other waveform shapes can be used, such as a trapezoidal waveform, etc.

The inner housing 320 can be held still by providing appropriate voltages to the electrodes 312a-c. For example, at FIG. 32, the inner housing can be held still by applying a relatively high voltage to the first electrodes 312a, and by applying a relatively low voltage (or now voltage) to the electrodes 312b and 312c. The inner housing 320 be driven forward and backward, and at various different speeds and intervals, by applying voltages to the electrodes 312a-c. In some embodiments, a single degree of freedom is available (e.g., front/back motion). In some embodiments, six degrees of freedom are available, and any combination of available types of motion can be implemented. The inner housing 320 and/or lens element 302 can be tilted by driving different electrodes on different sides. For example, if the upper electrodes were driven as shown in FIG. 19, while the lower electrodes were driven as shown in FIG. 18, the inner housing 320 and associated lens element 302 would tilt (e.g., to angle the optical axis downward). Various tilt angles and amounts could be implemented, depending on which electrodes are driven. Pitch and yaw, and combinations thereof, can be implemented in this manner. Roll can be implemented to rotate the inner housing 320 and/or lens element 302 about its axis, such as by driving adjacent electrodes that are neighboring in the circumferential direction. For example, a grid of electrodes can be used like that shown in FIG. 22, for example. In some embodiments, lateral movement can be implemented (e.g., up/down and/or left/right movement) similar to FIGS. 8 and 11. Multiple neighboring electrodes can be driven together (e.g., as a group) so that the fluid body spreads over the multiple electrodes. Changing the numbers of electrodes that are driven together in the groups can control the shape of the fluid bodies. For example, fluid bodies on one side can be flattened (e.g., by increasing the number of electrodes that are substantially covered by the fluid bodies) and/or fluid bodies on an opposing side can be heightened (e.g., by reducing the number of electrodes that are substantially covered by the fluid bodies), which can shift the inner housing 320 and/or lens element 302 laterally. This can also provide for more granular available motion in other directions, such as tilt and axial movement. By way of example, the system can vary the number of electrodes driven to control the shape of a fluid body between 1 electrode, 2 electrodes, 4 electrodes, 6 electrodes, 9 electrodes, 12 electrodes, 16 electrodes, 20 electrodes, 25 electrodes, 30 electrodes, 40 electrodes, or more, or any values or ranges therein, although other configurations are possible.

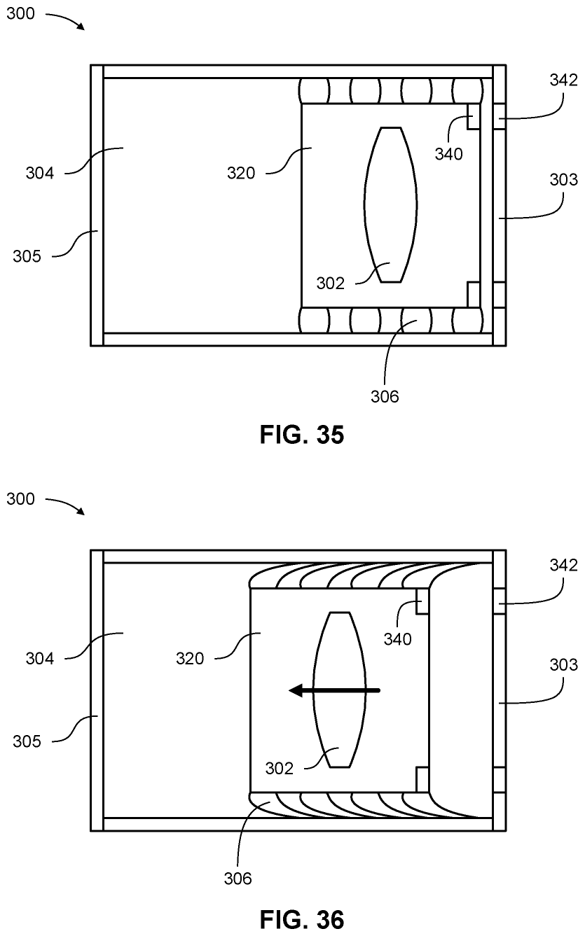

Many variations and alternatives are possible. Many example embodiments discuss using electrowetting to move a lens element or housing element. Other actuation techniques can be used. For example a magnetorheological fluid can be used, and one or more magnets (e.g., electromagnets) can be used to drive the fluid. Areas on the lens element, movable inner housing, and/or chamber surface can have a magnetic material (e.g., iron or another magnetic metal) for coupling one or more fluid bodies of the magnetorheological fluid thereto. The magnetorheological fluid can be ferrofluid, in some cases. In some cases, fluid can be used to suspend the lens element, or housing element and other actuation devices or techniques can be used to move the lens element or housing element, etc. FIGS. 35 and 36 illustrate an example embodiment that uses fluid to suspend the inner housing 320 in the chamber 304, and uses magnetism to move the inner housing element 320. The inner housing 320 can have one or more magnetic areas 342, such as an iron or other metal coating that is magnetic. The outer housing can include one or more magnets (e.g., electro magnets) 342, which can be move the inner housing 320 (e.g., axially). The fluid 306 can be coupled to the inner housing 320 and/or to the outer housing by the wetting properties thereof, as discussed herein. The fluid can provide suspension and centering for the inner housing 320 and/or lens element 302. In some implementations, different signals can be applied to different electromagnets to move the inner housing 320 and/or lens element 302 laterally or to a tilted position.

In some case, the moving lens system does not include a piezoelectric or ultrasonic motor, or a voice coil motor. In some embodiments, the system does not include any bearings or flexures or grease for moving parts. The movable lens systems disclosed herein can be made small, such as having a width and/or height of about 20 mm, about 10 mm, about 5 mm, about 3 mm, about 2 mm, about 1 mm, about 750 microns, about 500 microns, about 250 microns, about 100 microns, about 75 microns, about 50 microns, about 25 microns, about 10 microns, or any values therebetween, or any ranged bounded by any of these values.

Some embodiments can provide reduced chromatic aberration, less dispersion, and/or less color splitting, as compared to traditional movable lens systems. Using a liquid lens to change the curvature of the lens to vary the focal length can be used to make a zoom lens with reduced aberration. In some cases, moving a lens (e.g., a solid lens) laterally to implement OIS can reduce chromatic aberration, as compared to tilting a liquid lens. The tilted liquid lens, in some cases, and operate as a prism, especially if significant physical tilt of the fluid interface is needed to provide sufficient optical tilt for OIS.

In various embodiments, an optical device 410 is provided. The optical device 410 includes an optical member 414 positioned at an interface 418 between a first liquid 422 and a second liquid 426. The optical member 414 is positionally actuated using the first liquid 422 and the second liquid 426.

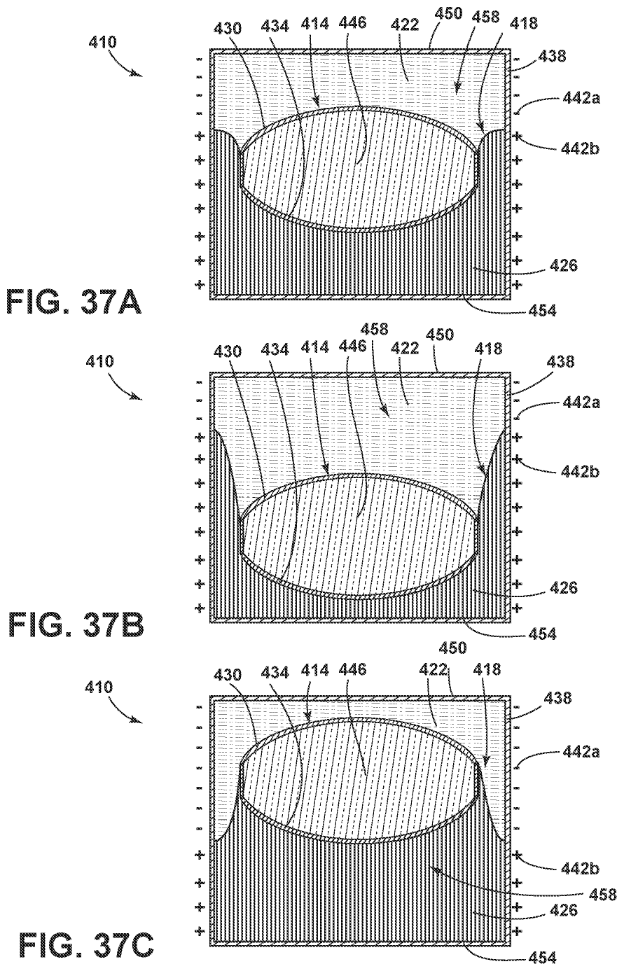

Referring to FIGS. 37A-37C, a group of schematic cross-sectional views of the optical device 410 positionally actuating the optical member 414 in an up-down vertical direction (e.g., axial direction) according to some embodiments of the present disclosure is provided. In some aspects, the movement of the optical member 414 in the up-down vertical direction may provide a single piece zoom lens with up to 5× zoom capabilities, although other zoom amounts are also possible. In some embodiments the optical device 410 includes a first window 450, a second window 454, and a cavity 458. The cavity 458 can be disposed between the first window 450, the second window 454, and sidewalls. The first liquid 422 (e.g. conductive or polar liquid) and the second liquid 426 (e.g. non-conductive or oil) can be substantially immiscible with each other and may be disposed within the cavity 458. The optical member 414 may be positioned at the interface 418 formed using the immiscible first liquid 422 and second liquid 426. For example, the optical member 414 can be sandwiched between the first liquid 422 and the second liquid 426 where the optical member 414 can help maintain its positioning at the interface 418 through a combination of hydrophilic coatings 430 and/or hydrophobic coatings 434. For example, the optical member 414 may have one or more hydrophobic coatings 434 on its bottom and sides where it is in contact with the oily or nonconductive second liquid 426. Alternatively or additionally, the optical member 414 may have one or more hydrophilic coatings 430 on its top side where the lens member 414 is in contact with the aqueous or conductive first liquid 422. Additionally, in some embodiments, hydrophobic and/or hydrophilic coatings may be added to the interior walls or windows of the optical device 410 to contact the respective first liquid 422 and second liquid 426.

As illustrated in FIGS. 37B and 37C, the optical member 414 may be positionally actuated in an up-down vertical direction as the interface 418 moves using the first liquid 422, second liquid 426, and electrowetting principles. Electrowetting may be applied to the first liquid 422 and second liquid 426 using an electrode 438 or metal blanket 438 positioned along two or more sidewalls of the optical device 410. In some embodiments, the sidewalls may be segmented to variably control the applied voltage 442 as a negative voltage 442a or a positive voltage 442b (or no voltage differential) to introduce anti-wetting and wetting surfaces. In some embodiments, each segment of the sidewall may include at least one electrode to independently apply a voltage to vary the interface 418 of the first liquid 422 and second liquid 426. In some embodiments, the metal blanket 438 may at least partially diffuse into one or more glass sidewalls to facilitate bonding of the metal blanket 438 to the optical device 410 to form at least one electrode 438 and/or conducting surface. When the voltage differential is increased across the optical device 410, the wettability for the first liquid 422 is increased and may push the second liquid 426 down or away. On the contrary, when the voltage differential is decreased across the optical device 410, the wettability for the first liquid 42 is decreased and the first liquid 422 may recede or be push back from the second liquid 426.

For example, in some embodiments, one or more segments of the electrode 438 may define a common electrode (e.g., disposed at an upper portion of the sidewalls as shown in FIGS. 37A-37C) in electrical communication with the first liquid 422. Additionally, or alternatively, one or more segments of the electrode 438 may define a driving electrode (e.g., disposed at a lower portion of the sidewalls as shown in FIGS. 37A-37C) that is insulated from the first liquid 422 and the second liquid 426 (e.g., by a hydrophobic dielectric layer or material). Changing a voltage differential between the common electrode and the driving electrode can change the wettability of the interior surface of the cavity 458 (e.g., the interior sidewalls of the cavity defined by the hydrophobic dielectric layer or material). For example, increasing the voltage differential can increase the wettability of the sidewalls with respect to the first liquid 422, causing the interface between the first liquid and the second liquid 426 to move downward along the sidewalls. Conversely, decreasing the voltage differential can decrease the wettability of the sidewalls with respect to the first liquid 422, causing the interface between the first liquid and the second liquid 426 to move upward along the sidewalls. In some embodiments, the driving electrode comprises a plurality of driving electrode segments. For example, the driving electrode segments can be distributed about the cavity 458 such that different voltages can be applied to different driving electrodes or electrode segments, and different portions of the interface between the first liquid 422 and the second liquid 426 can be positioned at different positions along the sidewalls of the cavity. Such a configuration, in some embodiments, can enable tilting and/or rotation of the optical member 414 within the cavity 458.

Referring now to FIG. 37B, a voltage differential is applied across the segmented sidewalls between the bottom (driving) electrodes and the top (common) electrode that moves the interface 418. In response to the electrowetting surface, the second liquid 426 advances up along the sidewall transferring a portion of the second fluid's 426 volume up into the cavity 458 along the sidewalls. To counteract the transferred volume of second liquid 426 up the wetted sidewalls, the first liquid 422 is simultaneously forced down against the top surface of the optical member 414 actuating or pushing the optical member 414 down from its original position illustrated in FIG. 37A. Accordingly, as anti-wetting is applied to the sidewalls of the optical device 410, the optical member 414 is positionally actuated down in a vertical direction using the electrowetting with the first liquid 422 and the second liquid 426.

Referring now to FIG. 37C, a voltage differential is applied across the segmented sidewalls between the bottom (driving) electrodes and the top (common) electrode that moves the interface 418. In response to the electrowetting surface, the second liquid 426 recedes down along the sidewall transferring a portion of the second fluid's 426 volume down into the cavity 458. To counteract the transferred volume of second liquid 26 moving down the wetted sidewalls, the second liquid 422 is forced up against the surface of the optical member 414 actuating or pushing the optical member 414 up from its original position as illustrated in FIG. 37A. In addition, to counteract the transferred volume of the second liquid 426 moving down the wetted sidewalls, the first liquid advances down along the sidewalls pushing the second liquid 426 down into the cavity 458. Accordingly, as wetting is applied to the sidewalls of the optical device 410, the optical member 414 is positionally actuated up in a vertical direction using electrowetting with the first liquid 422 and the second liquid 426.

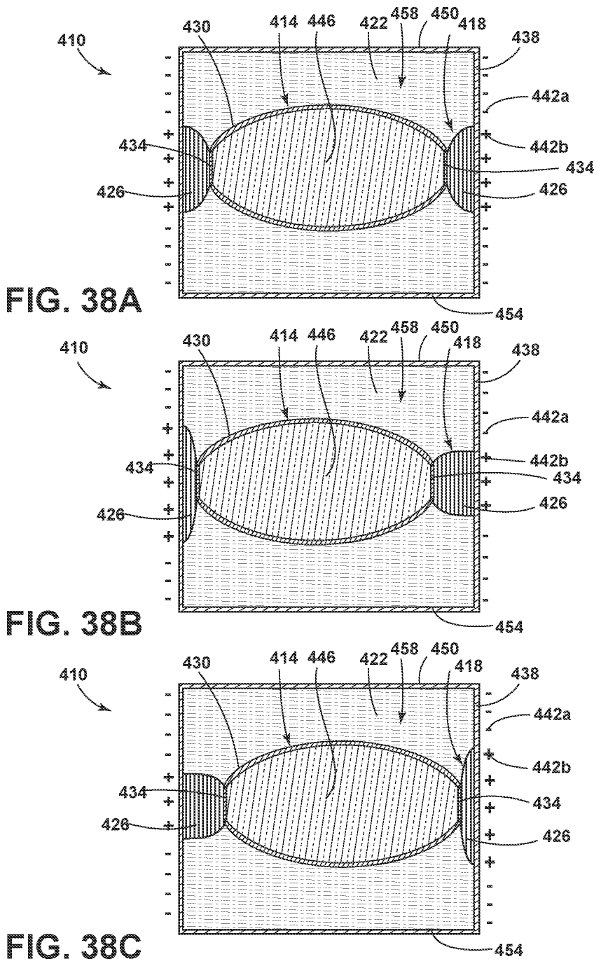

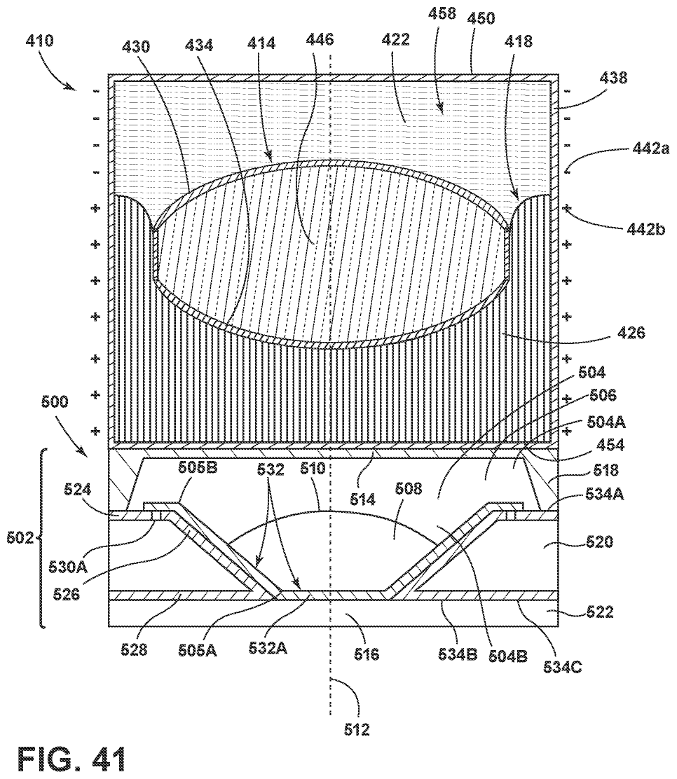

Referring to FIGS. 38A-38C, a group of schematic cross-sectional views of the optical device 410 positionally actuating the optical member 414 in a left-right horizontal direction (e.g., laterally) and/or a rotational direction about an optical axis 512 (see FIG. 41) according to some embodiments of the present disclosure is provided. The optical device 410 includes the first window 450, the second window 454, and the cavity 458. The first liquid 422 (e.g. conductive or polar liquid) may be positioned above and below the optical member 414 and the second liquid 426 (e.g. non-conductive or oil) may be positioned to the left and right sides of the optical member 414. The first liquid 422 and the second liquid 426 can be immiscible with each other and form two sets of interfaces 418. The optical member 414 may be positioned at the interface 418. The optical member 414 can be sandwiched between a first volume of the first liquid 422 positioned above and a second volume of the first liquid positioned below the optical member 414 and additionally sandwiched between a first volume of the second liquid 426 positioned to the left side and a second volume of the second liquid positioned to the right side of the optical member 414. The optical member 414 can help maintain its positioning at these interfaces 418 through the use of hydrophilic coatings 430 and/or hydrophobic coatings 434. For example, the optical member 414 may have hydrophobic coatings 434 on its left and right sides where the optical member 414 is in contact with the oily or non-conductive second liquid 426. Alternatively, the optical member 414 may have hydrophilic coatings 430 on its top and bottom sides where the optical member 414 is in contact with the aqueous or conductive first liquid 422.

As illustrated in FIGS. 38B and 38C, in some embodiments, the optical member 414 may be positionally actuated in a left-right horizontal direction along the moving interface 418 using electrowetting principles with the first liquid 422 and second liquid 426. Electrowetting may be applied to the first liquid 422 and second liquid 426 using the electrode 438 positioned along two or more sidewalls of the optical device 410. In some embodiments, the sidewalls may be segmented to variably control the applied voltage 442 as the negative voltage 442a or the positive voltage 442b to introduce anti-wetting and wetting surfaces. In some embodiments, each segment of the sidewall may include at least one electrode to independently apply a voltage to vary the interface 418 of the first liquid 422 and second liquid 426. When the voltage differential is increased across the optical device 410, the wettability for the first liquid 422 is increased and may push the second liquid 426 down or away. On the contrary, when the voltage differential is decreased across the optical device 410, the wettability for the first liquid 422 is decreased and the first liquid 422 may recede or be push back from the second liquid 426.

Referring now to FIG. 38B, a decreased positive voltage 442b may be applied to the left sidewall to decrease the wettability of the surface in contact with the second liquid 426 with respect to the first liquid 422. The decreased wettability on the left sidewall decreases the corresponding contact angle with respect to the contact angle illustrated on the left sidewall surface presented in FIG. 38A, thereby pulling the apex of the first volume of second liquid 426 toward the sidewall and away from the optical axis. An increased positive voltage 442b may be applied to the right sidewall to increase the wettability of the surface in contact with the second liquid 426 with respect to the first liquid 422. The increased wettability on the right sidewall increases the corresponding contact angle with respect to the contact angle illustrated on the right sidewall surface presented in FIG. 38A, thereby pushing the apex of the second volume of second liquid 426 away from the sidewall and toward the optical axis. The decreased wettability on the left sidewall and the simultaneous increased wettability on the right sidewall corresponds to a right-to-left actuation for the optical lens member 414. Accordingly, as a decreased electrowetting voltage is applied to the left sidewall of the optical device 410 and an increased electrowetting voltage is applied to the right sidewall of the optical device 410, the optical lens member 414 is positionally actuated to the left in a horizontal direction.

Referring now to FIG. 38C, an decreased positive voltage 442b may be applied to the right sidewall to decrease the wettability of the surface in contact with the second liquid 426 with respect to the first liquid 422. The decreased wettability on the right sidewall decreases the corresponding contact angle with respect to the contact angle illustrated on the right sidewall surface presented in FIG. 38A, thereby pulling the apex of the first volume of second liquid 426 toward the sidewall and away from the optical axis. An increased positive voltage 442b may be applied to the left sidewall to increase the wettability of the surface in contact with the second liquid 426 with respect to the first liquid 422. The increased wettability on the left sidewall increases the corresponding contact angle with respect to the contact angle illustrated on the left sidewall surface presented in FIG. 38A, thereby pushing the apex of the second volume of second liquid 426 away from the sidewall and toward the optical axis. The decreased wettability on the right sidewall and the simultaneous increased wettability on the left sidewall corresponds to a left-to-right actuation for the optical lens member 414. Accordingly, as a decreased electrowetting voltage is applied to the right sidewall of the optical device 410 and an increased electrowetting voltage is applied to the left sidewall of the optical device 410, the optical lens member 414 is positionally actuated to the right in a horizontal direction. Other voltage combinations can be applied to create similar voltage differentials for moving the optical member 414.

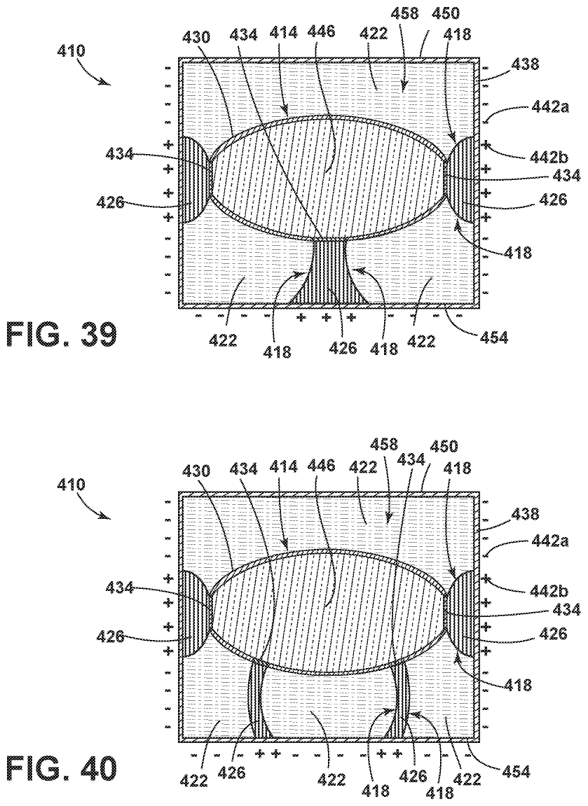

Referring now to FIG. 39, a schematic cross-sectional view of the optical device 410 able to positionally actuate the optical member 414 in a left-right horizontal direction (e.g., laterally) and an up-down vertical direction (e.g., axially) according to some embodiments of the present disclosure is provided. The optical device 410 may include the first window 450, the second window 454, and the cavity 458. The cavity 458 encloses the optical member 414 that may be positionally actuated in both a left-right horizontal direction and an up-down vertical direction using the first liquid 422 and the second liquid 426. The optical device 410 includes the first liquid 422 (e.g. conductive or polar liquid) positioned above and below the optical member 414 and the second liquid 426 (e.g. non-conductive or oil) positioned to the left and right sides of the optical member 414. In addition, the optical device 410 may include an additional column made from the second liquid 426 positioned directly beneath the lens member 414. In some embodiments, the first liquid 422 and the second liquid 426 may each have about identical refractive indices so images produced using the optical device 410 will not be distorted due to the different portions of the optical device having a combination of first liquid 422 and second liquid 426. The optical member 414 may be sandwiched between the first liquid 422 positioned above and below the optical member 414 and additionally sandwiched between the second liquid 426 positioned to the left and right sides of the optical member 414. The optical member 414 can help maintain its positioning at these interfaces 418 through hydrophilic coatings 430 and/or hydrophobic coatings 434. For example, the optical member 414 may have hydrophobic coatings 434 on its left and right sides in combination with a limited portion on its bottom side supported by the column where the optical member 414 is in contact with the oily or nonconductive second liquid 426. Alternatively, the optical member 414 may have hydrophilic coatings 430 on its top and bottom sides where the optical member 414 is in contact with the aqueous or conductive first liquid 422. Similar to the actuation mechanisms described in FIGS. 37A-37C and FIGS. 38A-38C, the column positioned directly beneath the lens member 414 may be positionally actuated via electrowetting to raise and lower the optical member 414 in an updown vertical direction. Combining the up-down vertical actuation provided by the column positioned directly beneath the lens member 414 with the left-right horizontal actuation provided embodiments where the optical member 414 may be moved using the first liquid 422 and the second liquid 426 in any combination in the x y z directions.

Referring now to FIG. 40, a schematic cross-sectional view of the optical device 410 able to positionally actuate the optical member 414 in a left-right horizontal direction (e.g., laterally) and an up-down vertical direction (e.g., axially) according to some embodiments of the present disclosure is provided. Rather than using the column positioned directly beneath the optical member 414, the optical member 414 is positioned above and in contact with a ring made from the second fluid 426. Similar to the positional actuation mechanisms already describe, the ring of second fluid 426 may be actuated using electrowetting to raise and lower the optical member 414. Combined with the second fluid 426 portions positioned on the ends of the optical member 414 as illustrated, the optical member 414 may be moved anywhere in a Cartesian coordinate system.

In each of the embodiments disclosed herein, the optical member 414 may include, but it not limited to, a plastic lens, a ball lens, a ball lens array, an actuated liquid lens, a biconcave lens, a biconvex lens, a plano-convex lens, a plano-concave lens, a negative meniscus lens, a positive meniscus lens, a convex-concave lens, or a concave-convex lens, a diffraction grating, or a combination thereof, or any other suitable optical component. The type of optical member 414 selected for use in the optical device 410 may vary based on the given application or the desired functionality. For example, in some embodiments, several of the optical members 414, e.g., a plastic lens or an actuated liquid lens, provided may be used in a zoom lens application. In some embodiments, the optical member 414 may include an actuated liquid lens where the optical device 410 can include a liquid lens inside a liquid lens. In embodiments where the optical member 414 includes a liquid lens positioned at the first liquid 422 and second liquid 426 interface 418, it may be possible to provide power through an induction process to manipulate the focal lengths of the liquid lens.

In some embodiments, the type of positional actuation is not mean to be limiting. In some embodiments, a single type of positional actuation may be provided to manipulate the images produced from the optical device. In other embodiments, any combination of different positional actuations may be provided to again suit the requirements needed from the optical device 410. In some embodiments, the optical member 414 may be positionally actuated in an optical tilt direction, in a left-right horizontal direction, in an up-down vertical direction, in a yaw rotational direction, or a combination thereof.

While the embodiments discussed in FIGS. 37A-40 disclose electrowetting techniques used to impart positional actuation in the optical device 410, the type of actuation is not meant to be limiting. For example, in some embodiments, the optical member 414 may be actuated using electrowetting, magneto rheological fluids, static electrofields, electrical actuation, or mechanical actuation. Electrowetting includes the modification of the wetting properties of a surface (which is typically hydrophobic) with an applied electric field. Magneto rheological fluids include a type of fluid that when subjected to a magnetic field, the fluid can greatly increase its apparent viscosity, to the point of becoming a viscoelastic solid. Static electrofields includes the imbalance of electric charges on different surface to use electrostatic repulsion and attraction to manipulate or actuate devices or materials. Electronic actuation involves the conversion of electricity into motion but do not generate usable mechanical powers in itself. In the embodiments disclosed herein, the type of positional actuation is not meant to be limiting unless specified otherwise. Also, the first liquid 422 and the second liquid 426 can be interchanged, and the driving approach can be modified accordingly. Although various embodiments are described as using liquids, any suitable fluids can be used, including liquid and gases. In some cases, an air gap or other gas can be included (not shown).

As described in more detail below in FIG. 41, a cell of an electrowetting optical device or liquid lens is generally defined by two transparent insulating plates and side walls. The lower plate, which is non-planar, comprises a conical or cylindrical depression or recess, which contains a non-conductive or insulating liquid. The remainder of the cell is filled with an electrically conductive liquid, non-miscible with the insulating liquid, having a different refractive index and substantially the same density. One or more driving electrodes are positioned on the side wall of the recess. An insulating thin layer may be introduced between the driving electrode(s) and the respective liquids to provide an electrowetting on the dielectric surface having long term chemical stability. A common electrode is in contact with the conductive liquid. Through electrowetting phenomena, it is possible to modify the curvature of the interface between the two liquids, according to the voltage V applied between the electrodes. Thus, a beam of light passing through the cell normal to the plates in the region of the drop will be defocused to a greater or lesser extent according to the voltage applied. The conductive liquid generally is an aqueous liquid containing salts. The nonconductive liquid is typically an oil, an alkane or a mixture of alkanes, possibly halogenated.

In some embodiments, the optical device 410 may include a actuated liquid lens as the optical member 414. The use of a liquid lens as the optical member 414 can provide an additional level of complexity and control over the optical device 410. For example, in addition to being able to move the liquid lens in the x y z direction, the use of a rotary transformer or other technique to provide power through an induction process to manipulate the focal lengths of the liquid lens is possible. The voltage differential can be controlled and adjusted to move an interface between the liquids (e.g., a meniscus) to a desired position along the sidewalls of the cavity. By moving the interface along sidewalls of the cavity, it is possible to change the focus (e.g., diopters), tilt, astigmatism, and/or higher order aberrations of the liquid lens. Further, during operation of the liquid lens, the dielectric and/or surface energy properties of the liquid lens and its constituents can change.

Referring now to FIG. 41, the optical device 410 includes the first window 450, the second window 454, and the cavity 458. The cavity 458 can be disposed between the first window 450 and the second window 454. The first liquid 422 (e.g. conductive or polar liquid) and the second liquid 426 (e.g. non-conductive or oil) can be substantially immiscible with each other and may be disposed within the cavity 458. The immiscible first liquid 422 and second liquid 426 can form the interface 418 where the optical member 414 may be positioned at this interface 418. The optical member 414 can be sandwiched between the first liquid 422 and the second liquid 426 where the lens member 414 can help maintain its positioning at the interface 418 through hydrophilic coatings 430 and/or hydrophobic coatings 434. For example, the optical member 414 may have hydrophobic coatings 434 on its bottom and sides where it is in contact with the oily or non-conductive second liquid 426. Alternatively, the optical member 414 may have hydrophilic coatings 430 on its top side where the lens member 414 is in contact with the aqueous or conductive first liquid 422.

In some embodiments, the optical device 410 may be coupled in optical communication with a liquid lens 500. A simplified cross-sectional view of an exemplary liquid lens 500 is provided. The structure of the liquid lens 500 is not meant to be limiting and may include any structure known in the art. In some embodiments, the liquid lens 500 may comprise a lens body 502 and a cavity 504 formed in the lens body 502. A first liquid 506 and a second liquid 508 may be disposed within cavity 504. In some embodiments, first liquid 506 may be a polar liquid, also referred to as the conducting liquid. Additionally, or alternatively, second liquid 508 may be a non-polar liquid and/or an insulating liquid, also referred to as the non-conducting liquid. In some embodiments, first liquid 506 and second liquid 508 may be immiscible with each other and have different refractive indices such that an interface 510 between the first liquid and the second liquid forms a lens. In some embodiments, first liquid 506 and second liquid 508 may have substantially the same density, which can help to avoid changes in the shape of interface 510 as a result of changing the physical orientation of liquid lens 500 (e.g., as a result of gravitational forces).

In some embodiments of the liquid lens 500 depicted in FIG. 41, cavity 504 may include a first portion, or headspace, 504A and a second portion, or base portion, 504B. For example, second portion 504B of cavity 504 may be defined by a bore in an intermediate layer of liquid lens 500 as described herein. Additionally, or alternatively, first portion 504A of cavity 504 may be defined by a recess in a first outer layer of liquid lens 500 and/or disposed outside of the bore in the intermediate layer as described herein. In some embodiments, at least a portion of first liquid 506 may be disposed in first portion 504A of cavity 504. Additionally, or alternatively, second liquid 508 may be disposed within second portion 504B of cavity 504. For example, substantially all or a portion of second liquid 508 may be disposed within second portion 504B of cavity 504. In some embodiments, the perimeter of interface 510 (e.g., the edge of the interface in contact with the sidewall of the cavity) may be disposed within second portion 504B of cavity 504.

Interface 510 of the liquid lens 500 (see FIG. 41) can be adjusted via electrowetting. For example, a voltage can be applied between first liquid 506 and a surface of cavity 504 (e.g., one or more driving electrode(s) positioned near the surface of the cavity 504 and insulated from the first liquid 506 as described herein) to increase or decrease the wettability of the surface of the cavity 504 with respect to the first liquid 506 and change the shape of interface 510. In some embodiments, adjusting interface 510 may change the shape of the interface 510, which changes the focal length or focus of liquid lens 500. For example, such a change of focal length can enable liquid lens 500 to perform an autofocus function. Additionally, or alternatively, adjusting interface 510 may tilt the interface relative to an optical axis 512 of liquid lens 500. For example, such tilting can enable liquid lens 500 to perform an optical image stabilization (OIS) function in addition to providing astigmatism variations or higher order optical aberration corrections. Adjusting interface 510 may be achieved without physical movement of liquid lens 500 relative to an image sensor, a fixed lens or lens stack, a housing, or other components of a camera module in which the liquid lens 500 can be incorporated.

In some embodiments, lens body 502 of liquid lens 500 may include a first window 514 and a second window 516. In some of such embodiments, cavity 504 may be disposed between first window 514 and second window 516. In some embodiments, lens body 502 may comprise a plurality of layers that cooperatively form the lens body 502. For example, in the embodiments shown in FIG. 41, lens body 502 may comprise a first outer layer 518, an intermediate layer 520, and a second outer layer 522. In some of such embodiments, intermediate layer 520 may comprise a bore formed therethrough. First outer layer 518 may be bonded to one side (e.g., the object side) of intermediate layer 520. For example, first outer layer 518 may be bonded to intermediate layer 520 at a bond 534A. Bond 534A may be an adhesive bond, a laser bond (e.g., a laser weld), a mechanical closing, or any another suitable bond capable of maintaining first liquid 506 and second liquid 508 within cavity 504. Additionally, or alternatively, second outer layer 522 may be bonded to the other side (e.g., the image side) of intermediate layer 520. For example, second outer layer 522 may be bonded to intermediate layer 520 at a bond 534B and/or a bond 534C, each of which can be configured as described herein with respect to bond 534A. In some embodiments, intermediate layer 520 may be disposed between first outer layer 518 and second outer layer 522, the bore in the intermediate layer may be covered on opposing sides by the first outer layer 518 and the second outer layer 522, and at least a portion of cavity 504 may be defined within the bore. Thus, a portion of first outer layer 518 covering cavity 504 may serve as first window 514, and a portion of second outer layer 522 covering the cavity may serve as second window 516.

In some embodiments, cavity 504 may include first portion 504A and second portion 504B. For example, in the embodiments shown in FIG. 41, second portion 504B of cavity 504 may be defined by the bore in intermediate layer 520, and first portion 504A of the cavity may be disposed between the second portion 504B of the cavity 504 and first window 514. In some embodiments, first outer layer 518 may comprise a recess as shown in FIG. 41, and first portion 504A of cavity 504 may be disposed within the recess in the first outer layer 518. Thus, first portion 504A of cavity 504 may be disposed outside of the bore in intermediate layer 520.

In some embodiments, cavity 504 (e.g., second portion 504B of the cavity 504) may be tapered as shown in FIG. 41 such that a cross-sectional area of the cavity 504 decreases along optical axis 512 in a direction from the object side to the image side. For example, second portion 504B of cavity 504 may comprises a narrow end 505A and a wide end 505B. The terms “narrow” and “wide” are relative terms, meaning the narrow end 505A is narrower than the wide end 505B. Such a tapered cavity can help to maintain alignment of interface 510 between first liquid 506 and second liquid 508 along optical axis 512. In other embodiments, the cavity 504 is tapered such that the cross-sectional area of the cavity 504 increases along the optical axis in the direction from the object side to the image side or non-tapered such that the cross-sectional area of the cavity 504 remains substantially constant along the optical axis.

In some embodiments, image light may enter the liquid lens 500 depicted in FIG. 41 through first window 514, may be refracted at interface 510 between first liquid 506 and second liquid 508, and may exit the liquid lens 500 through second window 516. In some embodiments, first outer layer 518 and/or second outer layer 522 may comprise a sufficient transparency to enable passage of the image light. For example, first outer layer 518 and/or second outer layer 522 may comprise a polymeric, glass, ceramic, or glass-ceramic material. In some embodiments, outer surfaces of first outer layer 518 and/or second outer layer 522 may be substantially planar. Thus, even though liquid lens 500 can function as a lens (e.g., by refracting image light passing through interface 510), outer surfaces of the liquid lens 500 can be flat as opposed to being curved like the outer surfaces of a fixed lens. In other embodiments, outer surfaces of the first outer layer 518 and/or the second outer layer 522 may be curved (e.g., concave or convex). Thus, the liquid lens 500 may comprise an integrated fixed lens. In some embodiments, intermediate layer 520 may comprise a metallic, polymeric, glass, ceramic, or glass-ceramic material. Because image light can pass through the bore in intermediate layer 520, the intermediate layer 520 may or may not be transparent.

In some embodiments, liquid lens 500 (see FIG. 41) may include a common electrode 524 in electrical communication with first liquid 506. Additionally, or alternatively, liquid lens 500 may include one or more driving electrodes 526 disposed on a sidewall of cavity 504 and insulated from first liquid 506 and second liquid 508. Different voltages can be supplied to common electrode 524 and driving electrode(s) 526 to change the shape of interface 510 as described herein.

In some embodiments, liquid lens 500 (see FIG. 41) may include a conductive layer 528 at least a portion of which is disposed within cavity 504. For example, conductive layer 528 may comprise a conductive coating applied to intermediate layer 520 prior to bonding first outer layer 518 and/or second outer layer 522 to the intermediate layer. Conductive layer 528 may include a metallic material, a conductive polymer material, another suitable conductive material, or a combination thereof. Additionally, or alternatively, conductive layer 528 may include a single layer or a plurality of layers, some or all of which can be conductive. In some embodiments, conductive layer 528 may define common electrode 524 and/or driving electrode(s) 526. For example, conductive layer 128 may be applied to substantially the entire outer surface of intermediate layer 518 prior to bonding first outer layer 518 and/or second outer layer 522 to the intermediate layer. Following application of conductive layer 528 to intermediate layer 518, the conductive layer may be segmented into various conductive elements (e.g., common electrode 524 and/or driving electrode 526). In some embodiments, liquid lens 500 may comprise a scribe 530A in conductive layer 528 to isolate (e.g., electrically isolate) common electrode 524 and driving electrode 526 from each other. In some embodiments, scribe 530A may comprise a gap in conductive layer 528. For example, scribe 530A is a gap with a width of about 5 μm, about 10 μm, about 15 μm, about 20 μm, about 25 μm, about 30 μm, about 35 μm, about 40 μm, about 45 μm, about 50 μm, or any ranges defined by the listed values.

As also depicted in FIG. 41, the liquid lens 500 may include an insulating layer 532 disposed within the cavity 504, positioned on top of the driving electrode 526. For example, insulating element 532 may include an insulating coating applied to intermediate layer 520 prior to bonding first outer layer 518 and/or second outer layer 522 to the intermediate layer. In some embodiments, insulating element 532 may include an insulating coating applied to conductive layer 528 and second window 516 after bonding second outer layer 522 to intermediate layer 520 and prior to bonding first outer layer 518 to the intermediate layer. Thus, the insulating element 532 may cover at least a portion of conductive layer 528 within cavity 504 and second window 516. In some embodiments, insulating element 532 may be sufficiently transparent to enable passage of image light through second window 516 as described herein.

In some embodiments of the liquid lens 500 depicted in FIG. 41, the insulating element 532 may cover at least a portion of driving electrode 526 (e.g., the portion of the driving electrode disposed within cavity 504) to insulate first liquid 506 and second liquid 508 from the driving electrode. Additionally, or alternatively, at least a portion of common electrode 524 disposed within cavity 504 may be uncovered by insulating element 532. Thus, common electrode 524 may be in electrical communication with first liquid 506 as described herein. In some embodiments, insulating element 532 may comprise a hydrophobic surface layer of second portion 504B of cavity 504. Such a hydrophobic surface layer can help to maintain second liquid 508 within second portion 504B of cavity 504 (e.g., by attraction between the non-polar second liquid and the hydrophobic material) and/or enable the perimeter of interface 510 to move along the hydrophobic surface layer (e.g., by electrowetting) to change the shape of the interface as described herein.

In some embodiments, two or more diffraction gratings having a spacing about from about 8 nm to about 10 nm may be coupled to the second window 516 to split and/or diffract the light into several beams traveling in different directions. In some embodiments, the multiple diffraction grating may split and diffract the focused light beams relative to the optical axis 512 of liquid lens 500.

According to some embodiments, the electrowetting optical device includes a voltage source for applying an A.C. voltage to vary the meniscus formed between the conductive and non-conductive liquids to control the focal length of the lens. In some embodiments, the electrowetting optical device further includes a driver or similar electronic device for controlling the lens where the lens and driver or similar electronic device are integrated into the liquid lens. In other embodiments, the electrowetting optical device may include a plurality of lenses incorporating at least one driver or similar electronic device.

The electrowetting optical device may be used as or be part of a variable focal length liquid lens, an optical zoom, an ophthalmic device, a device having a variable tilt of the optical axis, an image stabilization device, a light beam deflection device, a variable illumination device, and any other optical device using electrowetting. In some embodiments, the liquid lens/electrowetting optical device may be incorporated or installed in any one or more apparatuses including, for example, a camera lens, a cell phone display, an endoscope, a telemeter, a dental camera, a barcode reader, a beam deflector, and/or a microscope.

While exemplary embodiments and examples have been set forth for the purpose of illustration, the foregoing description is not intended in any way to limit the scope of disclosure and appended claims. Accordingly, variations and modifications may be made to the above-described embodiments and examples without departing substantially from the spirit and various principles of the disclosure. All such modifications and variations are intended to be included herein within the scope of this disclosure and protected by the following claims.

Additional Details

In the disclosure provided above, apparatus, systems, and methods for control of a lens are described in connection with particular example embodiments. It will be understood, however, that the principles and advantages of the embodiments can be used for any other applicable systems, apparatus, or methods. While some of the disclosed embodiments may be described with reference to analog, digital, or mixed circuitry, in different embodiments, the principles and advantages discussed herein can be implemented for different parts as analog, digital, or mixed circuitry. In some figures, four electrodes (e.g., insulated electrodes) are shown. The principles and advantages discussed herein can be applied to embodiments with more than four electrodes or fewer than four electrodes.

The principles and advantages described herein can be implemented in various apparatuses. Examples of such apparatuses can include, but are not limited to, consumer electronic products, parts of the consumer electronic products, electronic test equipment, etc. The principles and advantages described herein relate to lenses. Examples products with lenses can include a mobile phone (for example, a smart phone), healthcare monitoring devices, vehicular electronics systems such as automotive electronics systems, webcams, a television, a computer monitor, a computer, a hand-held computer, a tablet computer, a laptop computer, a personal digital assistant (PDA), a refrigerator, a DVD player, a CD player, a digital video recorder (DVR), a camcorder, a camera, a digital camera, a copier, a facsimile machine, a scanner, a multi-functional peripheral device, a wrist watch, a clock, etc. Further, apparatuses can include unfinished products.

In some embodiments, the methods, techniques, microprocessors, and/or controllers described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. The instructions can reside in RAM memory, flash memory, ROM memory, EPROM memory, EEPROM memory, registers, hard disk, a removable disk, a CD-ROM, or any other form of a non-transitory computer-readable storage medium. Such special-purpose computing devices may also combine custom hard-wired logic, ASICs, or FPGAs with custom programming to accomplish the techniques. The special-purpose computing devices may be desktop computer systems, server computer systems, portable computer systems, handheld devices, networking devices or any other device or combination of devices that incorporate hard-wired and/or program logic to implement the techniques.

The processor(s) and/or controller(s) described herein can be coordinated by operating system software, such as iOS, Android, Chrome OS, Windows XP, Windows Vista, Windows 7, Windows 8, Windows Server, Windows CE, Unix, Linux, SunOS, Solaris, iOS, Blackberry OS, VxWorks, or other compatible operating systems. In other embodiments, the computing device may be controlled by a proprietary operating system. Conventional operating systems control and schedule computer processes for execution, perform memory management, provide file system, networking, I/O services, and provide a user interface functionality, such as a graphical user interface (“GUI”), among other things.

The processor(s) and/or controller(s) described herein may implement the techniques described herein using customized hard-wired logic, one or more ASICs or FPGAs, firmware and/or program logic which causes microprocessors and/or controllers to be a special-purpose machine. According to one embodiment, parts of the techniques disclosed herein are performed by a processor (e.g., a microprocessor) and/or other controller elements in response to executing one or more sequences instructions contained in a memory. Such instructions may be read into the memory from another storage medium, such as storage device. Execution of the sequences of instructions contained in the memory causes the processor or controller to perform the process steps described herein. In alternative embodiments, hard-wired circuitry may be used in place of or in combination with software instructions.

Moreover, the various illustrative logical blocks and modules described in connection with the embodiments disclosed herein can be implemented or performed by a machine, such as a processor device, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A processor device can be a microprocessor, but in the alternative, the processor device can be a controller, microcontroller, or state machine, combinations of the same, or the like. A processor device can include electrical circuitry configured to process computer-executable instructions. In another embodiment, a processor device includes an FPGA or other programmable device that performs logic operations without processing computer-executable instructions. A processor device can also be implemented as a combination of computing devices, e.g., a combination of a DSP and a microprocessor, a plurality of microprocessors, one or more microprocessors in conjunction with a DSP core, or any other such configuration. Although described herein primarily with respect to digital technology, a processor device may also include primarily analog components. For example, some or all of the rendering techniques described herein may be implemented in analog circuitry or mixed analog and digital circuitry.

Unless the context clearly requires otherwise, throughout the description and the claims, the words “comprise,” “comprising,” “include,” “including,” and the like are to be construed in an inclusive sense, as opposed to an exclusive or exhaustive sense; that is to say, in the sense of “including, but not limited to.” The words “coupled” or connected,” as generally used herein, refer to two or more elements that can be either directly connected, or connected by way of one or more intermediate elements. Additionally, the words “herein,” “above,” “below,” and words of similar import, when used in this application, shall refer to this application as a whole and not to any particular portions of this application. Where the context permits, words in the Detailed Description using the singular or plural number can also include the plural or singular number, respectively. The words “or” in reference to a list of two or more items, is intended to cover all of the following interpretations of the word: any of the items in the list, all of the items in the list, and any combination of the items in the list. All numerical values provided herein are intended to include similar values (e.g., within a range of measurement error).

Although this disclosure contains certain embodiments and examples, it will be understood by those skilled in the art that the scope extends beyond the specifically disclosed embodiments to other alternative embodiments and/or uses and obvious modifications and equivalents thereof. In addition, while several variations of the embodiments have been shown and described in detail, other modifications will be readily apparent to those of skill in the art based upon this disclosure. It is also contemplated that various combinations or sub-combinations of the specific features and aspects of the embodiments may be made and still fall within the scope of this disclosure. It should be understood that various features and aspects of the disclosed embodiments can be combined with, or substituted for, one another in order to form varying modes of the embodiments. Any methods disclosed herein need not be performed in the order recited. Thus, it is intended that the scope should not be limited by the particular embodiments described above.

Conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment. Any headings used herein are for the convenience of the reader only and are not meant to limit the scope.

Further, while the devices, systems, and methods described herein may be susceptible to various modifications and alternative forms, specific examples thereof have been shown in the drawings and are herein described in detail. It should be understood, however, that the invention is not to be limited to the particular forms or methods disclosed, but, to the contrary, the invention is to cover all modifications, equivalents, and alternatives falling within the spirit and scope of the various implementations described. Further, the disclosure herein of any particular feature, aspect, method, property, characteristic, quality, attribute, element, or the like in connection with an implementation or embodiment can be used in all other implementations or embodiments set forth herein. Any methods disclosed herein need not be performed in the order recited. The methods disclosed herein may include certain actions taken by a practitioner; however, the methods can also include any third-party instruction of those actions, either expressly or by implication.

The ranges disclosed herein also encompass any and all overlap, sub-ranges, and combinations thereof. Language such as “up to,” “at least,” “greater than,” “less than,” “between,” and the like includes the number recited. Numbers preceded by a term such as “about” or “approximately” include the recited numbers and should be interpreted based on the circumstances (e.g., as accurate as reasonably possible under the circumstances, for example ±1%, ±3%, ±5%, ±10%, ±15%, etc.). For example, “about 3.5 mm” includes “3.5 mm.” Recitation of numbers and/or values herein should be understood to disclose both the values or numbers as well as “about” or “approximately” those values or numbers, even where the terms “about” or “approximately” are not recited. For example, recitation of “3.5 mm” includes “about 3.5 mm.” Phrases preceded by a term such as “substantially” include the recited phrase and should be interpreted based on the circumstances (e.g., as much as reasonably possible under the circumstances). For example, “substantially constant” includes “constant.” Unless stated otherwise, all measurements are at standard conditions including ambient temperature and pressure.

For purposes of description herein, in some instances the terms “upper,” “lower,” “right,” “left,” “rear,” “front,” “vertical,” “horizontal,” and derivatives thereof shall relate to the device as oriented in the Figures associated with the discussion. However, it is to be understood that the device may assume various alternative orientations and step sequences, except where expressly specified to the contrary. It is also to be understood that the specific devices and processes illustrated in the attached drawings, and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise.

As used herein, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination.

In this document, relational terms, such as first and second, top and bottom, and the like, are used solely to distinguish one entity or action from another entity or action, without necessarily requiring or implying any actual such relationship or order between such entities or actions.

Modifications of the disclosure will occur to those skilled in the art and to those who make or use the disclosure. Therefore, it is understood that the embodiments shown in the drawings and described above are merely for illustrative purposes and not intended to limit the scope of the disclosure, which is defined by the following claims, as interpreted according to the principles of patent law, including the doctrine of equivalents.

For purposes of this disclosure, the term “coupled” (in all of its forms: couple, coupling, coupled, etc.) generally means the joining of two components directly or indirectly to one another. Such joining may be stationary in nature or movable in nature. Such joining may be achieved with the two components and any additional intermediate members being integrally formed as a single unitary body with one another or with the two components. Such joining may be permanent in nature, or may be removable or releasable in nature, unless otherwise stated.

As used herein, the term “about” means that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art. When the term “about” is used in describing a value or an end-point of a range, the disclosure should be understood to include the specific value or end-point referred to. Whether or not a numerical value or end-point of a range in the specification recites “about,” the numerical value or end-point of a range is intended to include two embodiments: one modified by “about,” and one not modified by “about.” It will be further understood that the end-points of each of the ranges are significant both in relation to the other end-point, and independently of the other end-point.

The terms “substantial,” “substantially,” and variations thereof as used herein are intended to note that a described feature is equal or approximately equal to a value or description. For example, a “substantially planar” surface is intended to denote a surface that is planar or approximately planar. Moreover, “substantially” is intended to denote that two values are equal or approximately equal. In some embodiments, “substantially” may denote values within about 10% of each other, such as within about 5% of each other, or within about 2% of each other.

As used herein the terms “the,” “a,” or “an,” mean “at least one,” and should not be limited to “only one” unless explicitly indicated to the contrary. Thus, for example, reference to “a component” includes embodiments having two or more such components unless the context clearly indicates otherwise.

The terms “non-miscible” and “immiscible” can refer to liquids that do not form a homogeneous mixture when added together or minimally mix when the one liquid is added into the other. In the present description and in the following claims, two liquids are considered non-miscible when their partial miscibility is below 2%, below 1%, below 0.5%, or below 0.2%, all values being measured within a given temperature range, for example at 20° C. The liquids herein have a low mutual miscibility over a broad temperature range including, for example, −30° C. to 85° C. and from −20° C. to 65° C.

1. A camera system comprising:
an imaging sensor;
a movable lens device that comprises:
a housing;
a microlens array disposed inside the housing, wherein microlens elements of the microlens array are configured to at least contribute to focusing of light onto the image sensor;
one or more fluid bodies made of a first fluid and coupled to the microlens array and to the housing to suspend the microlens array inside the housing;
a plurality of electrodes; and
a controller configured to deliver signals to the electrodes to move the microlens array to implement one or more of optical image stabilization, optical zoom, or autofocus.

2. The camera system of claim 1, wherein the controller is configured to deliver signals to the electrodes to move the microlens array to implement each of optical image stabilization, optical zoom, and autofocus.

3. The camera system of claim 1, comprising an optical zoom system, wherein the controller is configured to receive target zoom information, and determine the signals to deliver to the electrodes to move the microlens array to change magnification of an image provided to the imaging sensor.

4. The camera of claim 1, comprising an optical image stabilization system that includes a sensor that provides information indicative of camera motion, wherein the controller is configured to receive the information indicative of camera motion, and determine the signals to deliver to the electrodes to move the microlens array to at least partially compensate for the camera motion.

5. The camera system of claim 1, comprising an autofocus system, wherein the controller is configured to receive target focal information, and determine the signals to deliver to the electrodes to move the microlens array to change a focal length.

6. The camera system of claim 1, configured such that the signals to the electrodes change the area of contact between the fluid bodies and the housing, wherein increasing the area of contact pulls the microlens array closer to the corresponding electrode, and wherein decreasing the area of contact pushes the microlens array away from the corresponding electrode.

7. The camera system of claim 1, configured such that the signals to the electrodes cause the fluid bodies to move from a first area over a first electrode to a second area over an adjacent electrode.

8. An electrowetting device comprising:
a housing that contains a cavity;
a first window;
a second window, wherein an axis extends from the first window to the second window;
an optical element disposed inside the cavity;
an inner housing that holds the optical element;
one or more fluid bodies of a first fluid, wherein the fluid bodies are coupled to the inner housing and the housing, to suspend the optical element in the cavity;
a second fluid at least partially surrounding the one or more fluid bodies; and
one or more electrodes that are electrically insulated from the first fluid and the second fluid, wherein the electrodes are positioned so that signals applied to the one or more electrodes cause the one or more fluid bodies to move the inner housing and the optical element.

9. The electrowetting device of claim 8, further comprising one or more additional electrodes that are in electrical communication with the first fluid of the one or more fluid bodies, wherein the first fluid is electrically conductive, and wherein the second fluid is electrically insulating.

10. The electrowetting device of claim 8, further comprising a common electrode that is in electrical communication with the second fluid, wherein the first fluid is electrically insulating, and wherein the second fluid is electrically conductive.

11. The electrowetting device of claim 8, configured to move the optical element axially or laterally, or to tilt the optical element relative to the axis.

12. (canceled)

13. (canceled)

14. The electrowetting device of claim 8, configured to move the optical element with at least 5 degrees of freedom.

15. (canceled)

16. (canceled)

17. The electrowetting device of claim 8, wherein the optical element comprises a microlens array.

18. The electrowetting device of claim 8, wherein the optical element comprises a liquid lens.

19. The electrowetting device of claim 18, wherein the electrowetting device is configured to deliver signals to the liquid lens by induction.

20. The electrowetting device of claim 8, configured to deform shapes of the one or more fluid bodies to move the optical element.

21. The electrowetting device of claim 8, configured to move the one or more fluid bodies from one or more first electrodes to one or more second electrodes to move the optical element.

22. An electrowetting device comprising:
a first fluid disposed within a cavity and a second fluid disposed within the cavity, wherein at least one interface is between the first fluid and the second fluid;
an optical element disposed within the cavity and suspended by one or both of the first fluid or the second fluid;
a first electrode insulated from the first and second fluids;
a second electrode in electrical communication with the first fluid;
wherein adjusting a voltage differential between the first electrode and the second electrode causes movement of the optical element relative to the cavity;
wherein the optical element comprises a microlens array, a ball lens array, a biconvex lens, a plano-convex lens, a meniscus lens, a plano-concave lens, a biconcave lens, a Fresnel lens, a diffraction grating, or a combination thereof.

23. (canceled)

24. (canceled)

25. (canceled)

26. The electrowetting device of claim 22, wherein the movement of the optical element is caused at least in part by a change in wettability of a portion of an inside wall of the cavity relative to the first fluid or the second fluid resulting at least in part from adjusting the voltage differential.

27. (canceled)

28. (canceled)

29. (canceled)

30. The electrowetting device of claim 22, wherein the optical element is movable with at least 5 degrees of freedom.
